(19) United States
(12) Patent Application Publication
(10) Pub. No.: US 2026/0128864 A1
(43) Pub. Date: May 7, 2026

(54) SYSTEMS AND METHODS OF FACILITATING DOCUMENT VALIDATION

(71) Applicant: Token Economics Sas, Paris (FR)

(72) Inventor: REMY A. EISENSTEIN, Paris (FR)

(21) Appl. No.: 19/379,284

(22) Filed: Nov. 4, 2025

Related U.S. Application Data
(60) Provisional application No. 63/715,960, filed on Nov. 4, 2024.

(51) Int. Cl. H04L 9/08; H04L 9/32

(52) U.S. Cl. CPC H04L 9/0825; H04L 9/0861; H04L 9/3226; H04L 9/3236

(57) ABSTRACT

The present disclosure provides a method of facilitating document validation. Further, the method may include receiving one or more access requests from one or more first user devices associated with one or more first users. Further, the one or more access requests includes one or more first hash values, and one or more encryption keys. Further, the method may include retrieving one or more second hash values from one or more databases. Further, the method may include analyzing the one or more first hash values and the one or more second hash values. Further, the method may include generating one or more results based on the analyzing of the one or more first hash values and the one or more second hash values. Further, the method may include transmitting the one or more results to the one or more first user devices.

The current application claims a priority to the U.S. provisional patent application Ser. No. 63/715,960 filed on Nov. 4, 2025.

### FIELD OF THE INVENTION

The present disclosure generally relates to the field of data processing. More specifically, the present disclosure relates to systems and methods of facilitating document validation.

### BACKGROUND OF THE INVENTION

The present disclosure generally relates to the field of secure digital data management and verification technologies. More particularly, the disclosure pertains to systems and methods for facilitating secure verification of digital or digitized documents, including but not limited to academic credentials, legal contracts, government records, corporate certificates, and healthcare documents. The field of digital document verification is of critical importance in modern data-driven ecosystems where institutions and individuals increasingly rely on digital records for decision-making, compliance, and authentication. As organizations transition from paper-based systems to digital infrastructures, ensuring the authenticity, integrity, and confidentiality of documents has become a foundational requirement for maintaining trust in digital transactions.

The ability to verify the genuineness of digital documents in a secure, efficient, and tamper-proof manner is essential to prevent fraud, data manipulation, and identity theft. A desirable objective is to enable real-time, automated, and privacy-preserving verification of documents while maintaining the confidentiality of sensitive data and ensuring that such verification processes remain resistant to malicious interference or unauthorized modification. Achieving the objective requires technological frameworks that provide not only cryptographic security but also adaptive, scalable, and user-trust-enhancing mechanisms capable of supporting secure document management across diverse application domains such as education, corporate governance, healthcare, and government administration.

However, existing systems for digital document verification encounter numerous technical and operational challenges that hinder the realization of the objective. Traditional verification systems often rely on centralized authorities or third-party intermediaries, introducing vulnerabilities such as single points of failure, delayed authentication, and potential misuse of personal information. Many existing solutions lack dynamic response capabilities to detect and prevent fraudulent activities in real time, resulting in prolonged exposure of compromised credentials. Additionally, static document identifiers such as unencrypted or fixed QR codes can be easily duplicated, redirected, or manipulated, thereby allowing forged documents to appear legitimate.

Conventional digital security infrastructures also face difficulties in maintaining privacy and adaptability. Systems that store or process document data in plaintext form are exposed to unauthorized access, increasing the risk of data breaches. Furthermore, the systems generally lack interoperability, limiting the ability to collaborate securely across institutions and jurisdictions. The growing complexity of cyber threats further exacerbates the challenges. Sophisticated attacks targeting encryption weaknesses, authentication bypasses, or database tampering highlight the need for multi-layered protection mechanisms that can intelligently detect anomalies and prevent fraud. The absence of real-time notification frameworks leaves stakeholders uninformed when document authenticity is compromised, perpetuating reliance on outdated or invalid records.

Another persistent problem in the field lies in balancing security with performance and usability. High computational overhead from conventional encryption systems often results in latency during document verification, particularly in large-scale institutional deployments or resource-constrained environments. Similarly, users often encounter difficulties in verifying authenticity without specialized knowledge or access to dedicated infrastructure, limiting the practical adoption of digital verification technologies.

Emerging trends, including the advent of quantum computing and the proliferation of distributed data ecosystems, further expose the inadequacy of traditional document verification frameworks. Current systems are ill-equipped to handle post-quantum threats, decentralized verification scenarios, or privacy-preserving data sharing across heterogeneous networks. Moreover, the lack of intelligent fraud detection, adaptive algorithmic upgrades, and privacy-compliant analytics impedes the ability of the systems to evolve alongside technological progress.

Therefore, there is a need for improved methods and systems for facilitating document validation that can overcome one or more of the preceding problems.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating document validation. Further, the method may include receiving, using a communication device, one or more access requests from one or more first user devices associated with one or more first users. Further, the one or more access requests includes one or more first hash values, and one or more encryption keys. Further, the method may include retrieving, using a storage device, one or more second hash values from one or more databases. Further, the method may include analyzing, using a processing device, the one or more first hash values and the one or more second hash values. Further, the method may include generating, using the processing device, one or more results based on the analyzing of the one or more first hash values and the one or more second hash values. Further, the method may include transmitting, using the communication device, the one or more results to the one or more first user devices.

The present disclosure provides a system for facilitating document validation. Further, the system may include a communication device. Further, the communication device may be configured for receiving one or more access requests from one or more first user devices associated with one or more first users. Further, the one or more access requests includes one or more first hash values, and one or more encryption keys. Further, the communication device may be configured for transmitting one or more results to the one or more first user devices. Further, the system may include a processing device communicatively coupled with the communication device. Further, the processing device may be configured for analyzing the one or more first hash values and one or more second hash values. Further, the processing device may be configured for generating the one or more results based on the analyzing of the one or more first hash values and the one or more second hash values. Further, the system may include a storage device communicatively coupled with the processing device. Further, the storage device may be configured for retrieving the one or more second hash values from one or more databases.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating document validation, in accordance with some embodiments.

FIG. 4 illustrates a flowchart of a method 400 of facilitating document validation including generating, using the processing device 1004, at least one digital identifier, in accordance with some embodiments.

FIG. 5 illustrates a flowchart of a method 500 of facilitating document validation including generating, using the processing device 1004, at least one admin hash value of the at least one admin password using the at least one hash function, in accordance with some embodiments.

FIG. 6 illustrates a flowchart of a method 600 of facilitating document validation including generating, using the processing device 1004, a user-encrypted private key and a user-encrypted directory key using the at least one user password, in accordance with some embodiments.

FIG. 7 illustrates a flowchart of a method 700 of facilitating document validation including generating, using the processing device 1004, at least one message, in accordance with some embodiments.

FIG. 8 illustrates a flowchart of a method 800 of facilitating document validation including obtaining, using the processing device 1004, at least one user data identifier and at least one encrypted user data, in accordance with some embodiments.

FIG. 9 illustrates a flowchart of a method 900 of facilitating document validation including generating, using the processing device 1004, at least one alert, in accordance with some embodiments.

FIG. 10 illustrates a block diagram of a system 1000 of facilitating document validation, in accordance with some embodiments.

FIG. 11 illustrates a flowchart of a method 1100 of facilitating document validation including generating, using the processing device 1004, at least one notification, in accordance with some embodiments.

FIG. 12 illustrates a flowchart of an account registration process 1200, in accordance with some embodiments.

FIG. 13 illustrates a flowchart of an account creation process 1300 for at least one additional user, in accordance with some embodiments.

FIG. 14 illustrates a flowchart of an email confirmation 1400, in accordance with some embodiments.

FIG. 15 illustrates a flowchart of a certification process 1500, in accordance with some embodiments.

FIG. 16 illustrates a flowchart of a verification process 1600, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one” but does not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data fingerprinting, role-based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touchscreen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosed system addresses the issues by providing an automated, real-time verification platform that instantly confirms document authenticity. The approach substantially reduces the time and costs associated with manual verifications. Unlike traditional systems that rely on third-party verification, the present disclosed system eliminates intermediaries, thereby enhancing both security and efficiency. Furthermore, unlike web-based systems, which can be redirected or spoofed, the system uses a dedicated mobile application for smartphones and tablets, ensuring secure, controlled access. The origin of the mobile app can be traced through app store downloads, providing an additional layer of trust and security, as the source of the app is verifiable, unlike untraceable websites that can be exploited by malicious actors.

Key Cryptographic Techniques: The system employs SHA256, a cryptographic hash function that converts input data (e.g., document information) into a fixed-length string of characters, referred to as a “hash” or “fingerprint”. The hash is unique to the original data, ensuring that even minor changes result in significantly different hashes. The one-way process is computationally infeasible to reverse-engineer the original data from the hash. Hashing is widely used to verify the integrity of data, ensuring that the content has not been altered.

Encryption Mechanism: In addition to hashing, encryption is utilized to secure document data. Encryption transforms readable data (plaintext) into an encoded format (cipher text), which can only be decrypted with the corresponding key. The system uses both symmetric and asymmetric encryption techniques.

Addressing Vulnerabilities of Traditional Systems: The present system eliminates the risks by using cryptographic techniques to ensure both the confidentiality and authenticity of document data. Additionally, the use of a dedicated mobile application further mitigates risks, as the application's origin can be verified through app stores, unlike websites that are more vulnerable to fraudulent redirections.

Fraud Prevention and QR Code Deactivation: In cases of fraud or misconduct, the associated QR code can be deactivated, preventing further misuse of fraudulent credentials. The real-time deactivation feature adds a dynamic security layer, which is absent in traditional systems.

Role of the Database: The system's database securely stores encrypted document data, including SHA256 hashes, 64-character reading keys, and document IDs. The data can only be accessed and decrypted through the system's cryptographic processes during verification, ensuring that document information remains secure.

The present disclosed system provides a secure platform enabling institutions to digitally manage, certify, and verify the authenticity of documents. The system generates secure QR codes embedded with encrypted document data, which can be verified instantaneously through a dedicated mobile application. The platform is designed for deployment in academic institutions, corporate human resources departments, and government agencies, facilitating the verification of documents, contracts, and certificates. Unlike systems that merely rely on abstract cryptographic algorithms, the present disclosed system offers a practical, real-world application, delivering a fast, reliable, and secure solution for preventing document fraud.

Further, the administrator's browser, or that of a designated user, encrypts document data, which is subsequently stored in an encrypted format within a secure database. A unique QR code is generated for each document to allow rapid and secure verification.

Further, verification is conducted exclusively through a dedicated mobile application, developed for smartphones and tablets. The application is secured using cryptographic protocols to ensure that only authorized users can access and decrypt the QR codes. Unlike web-based systems, the mobile application offers an additional layer of security by being traceable to the app's origin through app store downloads, reducing the risk of unauthorized or fraudulent use. The mobile application decrypts the QR code, enabling employers and recruiters to promptly verify the authenticity of a candidate's credentials prior to making hiring decisions. The mobile application is the sole tool capable of reading and decrypting the QR code, thereby ensuring that the document data remains secure and can only be verified through the secure mobile platform.

Further, in cases of fraud or misconduct, the associated QR code can be deactivated by the administrator or a designated user, preventing further misuse of the document and rendering invalid for future verification attempts.

Further, the key feature of the present disclosed system includes: a) Account Management: An institution's administrator can create and manage accounts for additional users, securing the credentials through the use of cryptographic keys for encryption; b) Document Certification: Documents are encrypted using a combination of SHA256 hashing and 64-character symmetric keys. The encrypted document data is stored securely in a database, with a QR code affixed to the printed document, containing both the fingerprint (hash) and the decryption key. The encrypted document data is stored in a secure binary format (blob) that can only be accessed via the system's cryptographic processes; c) Verification: The QR code allows the authenticity of the document to be verified by querying the database without exposing the student's personal information. The process is conducted securely through the dedicated mobile application, ensuring that the verification is traceable to the application's origin through recognized app stores.

Further, the key innovation of the present disclosed system includes:
1. Elimination of Third-Party Intermediaries: The system eliminates the need for reliance on third-party intermediaries by securely encrypting and storing data directly within the own database, utilizing SHA256 hashing and a combination of asymmetric and symmetric encryption. The approach ensures both data integrity and confidentiality without external oversight, permitting only authorized users to access and manage the data, thereby enhancing privacy and security.
2. Encrypted QR Codes Readable Exclusively by a Dedicated Mobile Application: The system employs encrypted QR codes, which can only be decrypted through a dedicated mobile application. Ensuring that document verification can only be conducted by authorized parties and prevents potential misuse, such as the redirection of the QR code to fraudulent websites—an inherent vulnerability of traditional static QR code systems. Unlike web-based systems, the mobile application is traceable to the app's origin through trusted app store downloads, providing a secure verification process where the source of the app is known and trusted.
3. App store verification ensures that users download the authentic application through a combination of review processes, digital certificates, and security protocols that help protect against malicious imitations:
   a. Developer Verification: Before an app is made available on an app store (like Google Play or the Apple App Store), the developer must register and verify the identity with the store. Ensuring that only legitimate entities can publish apps, and the app is associated with an identified and authenticated developer.
   b. App Review Process: Most app stores conduct a security review of applications before the applications are listed. The review checks for malware, security vulnerabilities, and whether the app adheres to the store's policies and standards. The process helps ensure that apps are safe for users to download.
   c. Digital Signatures and Certificates: When an app is uploaded to an app store, the app is signed with a digital certificate issued by the app store. The certificate proves the app's authenticity and that the app has not been tampered with. Users can trust that the app and download the app which is created by the verified developer because the app's signature is checked before installation.
   d. Automatic Updates and Patch Management: App stores provide a controlled environment for automatic updates. If a security issue is found, the verified developer can quickly release a patch or update, which is delivered directly to users via the store, keeping the app up to date and secure.
   e. Protection against Clones and Imitations: If malicious actors attempt to create imitations or fake versions of legitimate apps, the apps are often detected and blocked by the store's security checks. The app's digital signature and store authentication prevent tampered or cloned versions from being published under the same name, helping users avoid counterfeit apps.
4. Real-Time Fraud Detection and QR Code Deactivation: Unlike conventional systems, the present disclosed system allows the real-time deactivation of QR codes in cases of fraud or misconduct. Administrators can instantly mark documents as invalid, effectively preventing any further use. The proactive fraud prevention feature sets apart from traditional methods, which lack the real-time adaptability.
5. Real-Time Notifications to Verifiers: A notable feature of the system is the ability, through the dedicated mobile app, to send real-time notifications to all prior verifiers when a QR code is deactivated due to fraud. The app, specifically designed to read and decrypt the QR codes, creates a secure feedback loop that ensures stakeholders who previously verified the document are immediately informed of the invalidation. The proactive approach prevents further reliance on compromised documents. The innovation is absent in traditional, website-linked QR code systems and blockchain-based verification systems, which lack real-time communication capabilities to notify verifiers post-verification.
6. Comprehensive Cryptographic Security: The system applies advanced cryptographic techniques to ensure that document data is never stored in plain text. A combination of SHA256 hashing, asymmetric encryption, and symmetric encryption ensures that all sensitive data remains encrypted throughout the lifecycle, safeguarding document security from creation to verification.
7. Instant and Automated Verification: The system enables immediate verification through a dedicated mobile application. Users can scan a unique QR code generated for each certified document, and the system will automatically query the database, decrypt the relevant data, and provide real-time verification results. Offers an improvement over traditional systems that rely on slow, manual processes. Furthermore, the traceability of the mobile application's origin to a legitimate source (e.g., app stores) adds another layer of security, ensuring that the application used for verification is trustworthy and untampered.
8. Scalability for High-Volume Usage: The system is designed with scalability in mind, capable of handling large volumes of certifications and verifications. Whether employed by small businesses or large institutions, the system's distributed infrastructure ensures consistent performance, even during peak usage times such as mass graduations or high-volume corporate transactions.

Further, the present disclosed system's integration of real-time fraud detection, QR code deactivation, advanced cryptographic security, and real-time notifications provides a non-obvious and proactive solution for document management and the adaptability ensures that document security and integrity are maintained throughout the document's lifecycle, offering a significant improvement over existing systems in the market. The traceability of the mobile application's origin to trusted app stores ensures that the app is a secure and verifiable component of the system, further distinguishing from less secure web-based solutions.

Further, the present disclosure system is designed with user experience as a priority. The dedicated mobile application offers a streamlined interface, allowing users to perform document verification actions quickly and easily, without compromising security:
1. Ease of Use: The mobile app's intuitive design ensures that verifiers, such as employers or credential evaluators, can scan and verify documents within seconds. By simply scanning the QR code, the app automatically queries the database, decrypts the relevant information, and displays the verification results in real-time. Eliminates the need for complicated manual verification processes, reducing administrative burdens.
2. Speed and Efficiency: While maintaining high-level cryptographic security, the system is optimized to ensure that verification is completed in real-time. Users can verify document authenticity instantly, even during high-volume periods such as mass graduations or large-scale corporate hiring events. The app is designed to deliver immediate feedback on document status, whether valid, invalid, or deactivated due to fraud.
3. Accessibility and Convenience: The mobile application is available across a range of devices, including smartphones and tablets, and can be easily downloaded from recognized app stores. Users can verify documents securely from anywhere, adding convenience and flexibility to the verification process.
4. Enhanced User Trust: Thanks to the app store verification process and the traceability of the app's origin, users can trust the interaction with the legitimate and secure app. Reassures verifiers that the system is free from malicious interference, further improving trust in the verification process.

Further, document verification systems, whether traditional, blockchain-based, or web-based QR code systems, exhibit several limitations in addressing real-time fraud detection and dynamic document management. The following is a detailed comparison of the systems with the present disclosed system:
1. Traditional Systems:
   a. Manual Verification: Many conventional systems rely on manual processes or third-party intermediaries to verify document authenticity. The methods introduce delays, potential errors, and increased susceptibility to fraud.
   b. Absence of Real-Time Fraud Detection: Traditional systems generally lack the capability to detect fraud in real-time, often depending on post-issue audits or manual checks to identify discrepancies.
   c. Dependence on Third Parties: Verifiers frequently depend on trusted third-party services to confirm document authenticity, increasing the risk of delays and introducing potential vulnerabilities.
2. Blockchain-Based Systems:
   a. Immutable Records: Blockchain systems rely on immutable records, which offer a high level of security but lack flexibility in adjusting a document's status or revoking authenticity in real-time.
   b. No Real-Time Feedback: Once a document is verified using blockchain, the system does not provide real-time feedback or notifications to previous verifiers if fraud is detected subsequently.
3. Static QR Code-Based Systems:
   a. Linkage to Websites: Static QR codes often link to specific websites. In cases of fraud, malicious actors can redirect the QR code to a fraudulent website, making the QR appear legitimate and deceiving users into verifying false information.
   b. Lack of Fraud Detection: Traditional QR code systems lack built-in mechanisms to detect or prevent ongoing fraud. Once generated, a static QR code becomes vulnerable to manipulation, as the link could be redirected to a fraudulent site. Leaving documents exposed after the initial verification, with no system in place to alert stakeholders to continued fraudulent activity.

Further, the present disclosed system introduces a synergistic combination of features designed to address the shortcomings inherent in traditional, blockchain-based, and QR code-based systems:
1. Encrypted QR Codes with Dedicated Mobile Application: Unlike traditional web-based QR codes, which are vulnerable to redirection to fraudulent websites, the present system utilizes dynamic encrypted QR codes. The QR codes can only be decrypted using a dedicated mobile application, ensuring that only authorized verifiers can access the document's information. Unlike web-based systems, the mobile application's origin is traceable through app store downloads, providing an additional layer of security by ensuring that the source of the app is trusted and verified, mitigates the risk of QR code redirection, a common vulnerability in conventional systems.
2. Real-Time Fraud Detection and QR Code Deactivation: The system enables real-time deactivation of QR codes upon the detection of fraud, preventing further misuse of compromised documents. The feature is absent in both blockchain-based and static QR code systems, offering a significant security enhancement.
3. Instant Notifications to Verifiers: In the event of fraud, the system sends real-time notifications to all previous verifiers who have interacted with the document. The proactive approach prevents further misuse of fraudulent documents and ensures that verifiers are promptly informed of an important feature not available in existing systems.
4. Cryptographic Integration for Dynamic Security: The system incorporates advanced cryptographic techniques to maintain continuous document security and confidentiality. Unlike blockchain and static web-based QR code systems, where data is immutable or static, the present system introduces real-time adaptability through end-to-end encryption combined with dynamic QR code management.

Further, the following is a comparison table describing the traditional systems, blockchain-based systems, static QR code systems, and the present disclosed system:

| | Traditional | Blockchain-Based | Static QR | Present Disclosed |
|---|---|---|---|---|
| Feature | Systems | Systems | Code Systems | system |
| Verification | Manual, often | Decentralized, | QR codes link | Direct real-time |
| Method | dependent on | immutable ledger | to static | verification with a |
| | third-party | for document | document | dedicated mobile |
| | verification | storage | records | application reading |
| | | | | dynamic encrypted |
| | | | | QR codes |
| Fraud | Often manual, | Reactive; fraud | No integrated | Real-time fraud |
| Detection | post-issuance | detected after | fraud detection | detection and |
| | | issuance | | prevention with |
| | | | | instant feedback |
| Document | No built-in | Immutable once | Static QR | Real-time |
| Deactivation | mechanism for | issued, no real- | codes cannot | deactivation of |
| | immediate | time deactivation | be updated or | QR codes when fraud |
| | revocation | | revoked | is detected |
| Notifications | Not available | No feedback loop | No mechanism | Instant notifications to |
| to Verifiers | | for previous | to notify | all previous verifiers |
| | | verifiers | previous | upon |
| | | | verifiers | QR Code deactivation |
| Third-Party | Dependent on | No third-party | No third-party | Eliminates third-party |
| Reliance | trusted third- | reliance | reliance | reliance via direct |
| | party services | | | verification |

Further, the cryptographic methods employed by the system, including SHA256 hashing asymmetric encryption, and symmetric encryption, are applied across various real-world contexts to secure critical documents such as documents, contracts, and medical records. The techniques are not implemented in isolation but are seamlessly integrated to enhance both the security and confidentiality of documents across multiple industries:
1. Academic Sector: In academic institutions, documents and certificates are encrypted using asymmetric encryption at the point of issuance, ensuring that the document remains secure and confidential from unauthorized access. A unique QR code is generated for each document, containing a hashed version of the document data along with a decryption key. Example: Upon a student's graduation, the student's document is stored in an encrypted format. Authorized users, such as employers or educational institutions, can access the document by scanning the QR code using the system's mobile application. The data is decrypted instantly on the device, allowing employers to verify the authenticity of the document in real-time.
2. Corporate and Legal Sectors: In corporate environments, the same cryptographic techniques are used to secure sensitive documents, such as employment contracts, non-disclosure agreements (NDAs), and court orders, ensures that the documents are both tamper-proof and confidential while allowing instant verification by authorized parties through QR code scanning. Example: During the hiring process, an employer can scan the QR code on an applicant's employment certificate to instantly retrieve the encrypted data. The system verifies the document against the database, ensuring that QR code has not been altered and confirming the authenticity.
3. Healthcare Sector: Healthcare providers can utilize the system to secure medical documents, such as prescriptions and medical records, ensures that sensitive medical data remains secure and confidential while still being readily accessible to authorized healthcare professionals. Example: A pharmacy can scan the QR code on a prescription to verify that the QR code matches the data encrypted and stored by the issuing healthcare provider, preventing the fulfillment of fraudulent prescriptions.

The practical integration of cryptographic techniques in the present system eliminates the need for outdated or manual verification methods. All data is stored and transmitted in encrypted formats, ensuring that even if intercepted, cannot be decoded without the appropriate decryption key. The end-to-end encryption and real-time verification capabilities make the system a versatile solution for industries that require high levels of data security, confidentiality, and operational efficiency.

The present disclosed system is adaptable across various sectors to meet the needs for secure certification, verification, and management of critical documents and provides fast, reliable, and secure verification without relying on third parties. Below are examples of the application in different industries:
1. Academic Institutions: In academic settings, universities can issue digitally certified documents with secure QR codes. Employers can instantly verify a graduate's credentials by scanning the QR code, ensuring that no forged documents enter the hiring process. Upon graduation, the institution generates a unique QR code linked to a secure, encrypted version of the document stored in the system's database. Employers, credential evaluators, or other academic institutions can verify the authenticity of the document by scanning the QR code through a dedicated mobile application, eliminating the need for manual document requests and reducing fraud. Example: When a student applies for a job, the employer scans the QR code on the document. The system instantly retrieves and decrypts the stored document information, confirming the validity and ensuring the credentials are legitimate.
2. Corporate Sector: HR departments can validate previous employment contracts or certificates by scanning the QR code, confirming the authenticity in real-time without relying on third parties. The system also certifies employment contracts, non-disclosure agreements (NDAs), and other corporate documents. Each document is assigned a unique QR code, streamlining the verification process for employees, clients, and stakeholders while ensuring the authenticity and confidentiality of the documents. Example: During the hiring process, an employer verifies a candidate's previous work experience by scanning the QR code on the employment certificate. The system confirms the document's validity, ensuring that the document has not been altered, and bolstering confidence in the hiring decision.
3. Legal Sector: Law firms and notaries can use the system to certify legal documents such as contracts, powers of attorney, and court orders. The system ensures that the sensitive documents are encrypted, tamper-proof, and easily verifiable by authorized parties. QR codes attached to each document allow for quick verification, ensuring the integrity of legal agreements. Example: In a real estate transaction, both buyer and seller can confirm the authenticity of contracts by scanning the QR code. The system securely verifies the document, preventing disputes over forged or altered contracts.
4. Healthcare: Healthcare providers can use the system to securely certify and verify medical documents such as prescriptions, patient records, and medical certificates and is especially useful for preventing fraud, such as forged prescriptions or misuse of medical certificates. Example: A pharmacy scans the QR code on a prescription to verify that the information matches the encrypted data stored in the hospital's database, preventing the fulfillment of forged prescriptions and ensuring that only legitimate documents are processed.
5. Government and Public Administration: Government agencies can use the system to certify official documents such as permits, licenses, identification cards, and public tenders. The documents, often subject to forgery, can be quickly verified by scanning the QR code, providing instant confirmation of the validity and preventing misuse or fraud. Example: A business applying for a government tender scans the QR code on the tender documents to verify the legitimacy of the information, preventing fraudulent claims and ensuring fair competition.
6. International Trade and Certifications: Exporters and certification bodies can use the system to certify and verify export documents, product certifications, and compliance reports. The system maintains the integrity and confidentiality of the documents, providing transparency and fostering trust in international transactions. Example: A product manufacturer exporting goods to another country can attach a QR code to the compliance certificates. Customs officials scan the QR code to verify the certification's authenticity, facilitating smoother border clearance and ensuring compliance with regulations.

Further, the present disclosed system is designed with high scalability, suitable for institutions of all sizes, including large organizations that handle significant volumes of document certifications and verifications. The system's API integrates seamlessly with existing document management systems, enabling institutions to automate the certification process. For large organizations, the system can handle millions of certifications and verifications, ensuring high levels of security without compromising performance. The flexibility makes the system a practical solution for both small businesses and large entities such as universities and multinational corporations, which process high volumes of sensitive documents.

Key features supporting scalability include the following:
1. Automated Document Processing via API Integration: The system's API automates the certification and verification of documents, streamlining workflows for large institutions, including universities, government agencies, and multinational corporations. The automation minimizes manual intervention, enabling efficient bulk document processing.
2. Distributed Infrastructure: The system can be deployed in a cloud-based environment or across a distributed network, allowing for dynamic scaling based on demand, ensures that the system can handle peak loads-such as during graduation seasons for educational institutions or high-transaction periods in corporate environments-without latency or performance issues.
3. Efficient Data Management: The system employs optimized encryption techniques and secure storage methods, ensuring efficient storage and retrieval of document records, even as the database grows and makes the system ideal for long-term archival and retrieval, especially in industries where records must be maintained and verified over extended periods.
4. Adaptability to Various Document Types: The system supports multiple document formats, including documents, contracts, certifications, and legal documents. The capability enhances scalability by allowing institutions to standardize the document management processes across different departments and use cases.

With the features, the present disclosed system can scale effortlessly to accommodate the growing needs of any organization, offering both cost efficiency and high performance as document volumes increase. Whether managing documents for academic institutions or issuing licenses for government agencies, the system provides a flexible, robust solution that adapts to the specific scalability requirements of each entity.

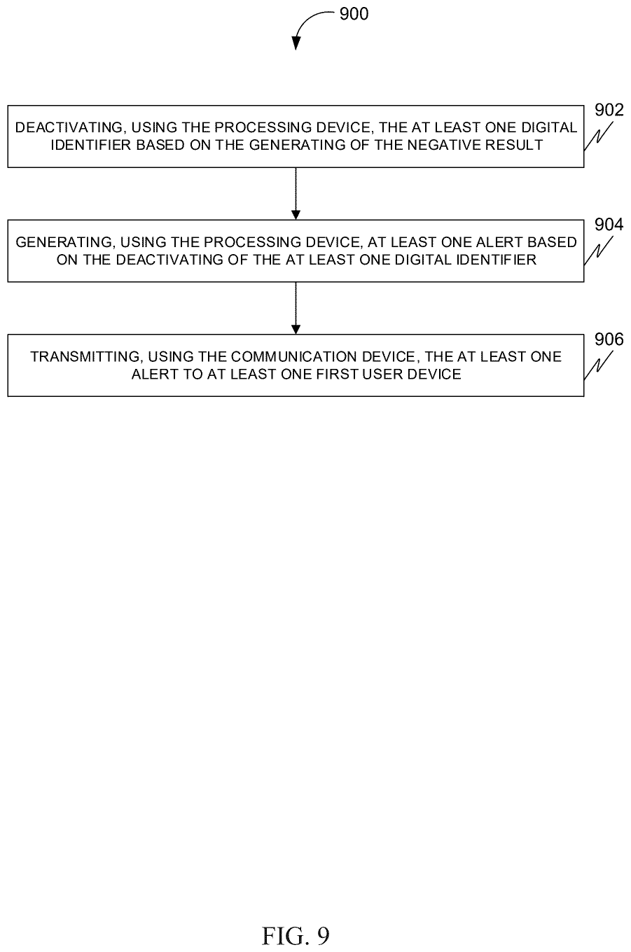

FIG. 9 illustrates a flow diagram of an account registration process for facilitation of verification of a document, in accordance with some embodiments. Accordingly, the Account Registration Process includes Administrator Registration: the method includes the generation of cryptographic keys and encryption of user data, after which the administrator account will be validated by the system's database administrator. Further, the administration registration includes:
1. Key Generation: Upon registration, the administrator's browser randomly generates a public key, a private key for the institution, and a 64-character directory key.
2. Encryption: The administrator's browser:
   a. Symmetrically encrypts the public key, the private key, and the directory key using the administrator's password.
   b. Generates a SHA256 hash of the password for verification and security purposes.
3. Transmission: The encrypted public key, the encrypted private key, the encrypted directory key, and the SHA256 hash of the password are securely transmitted to the servers.

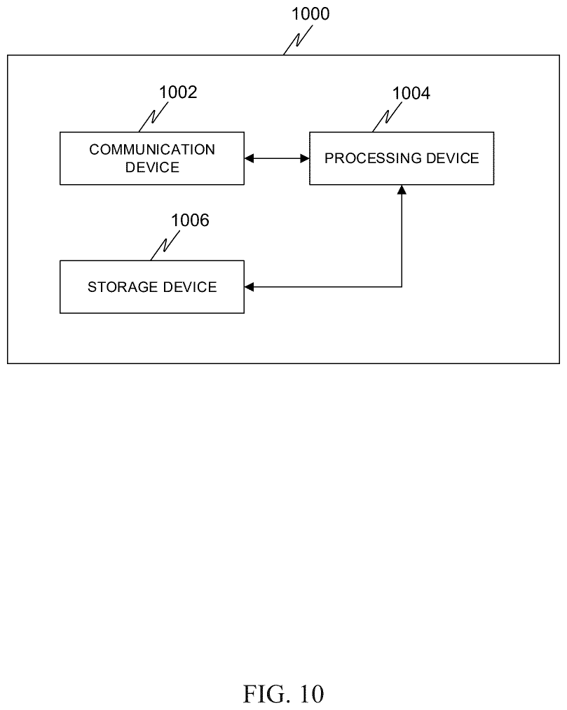

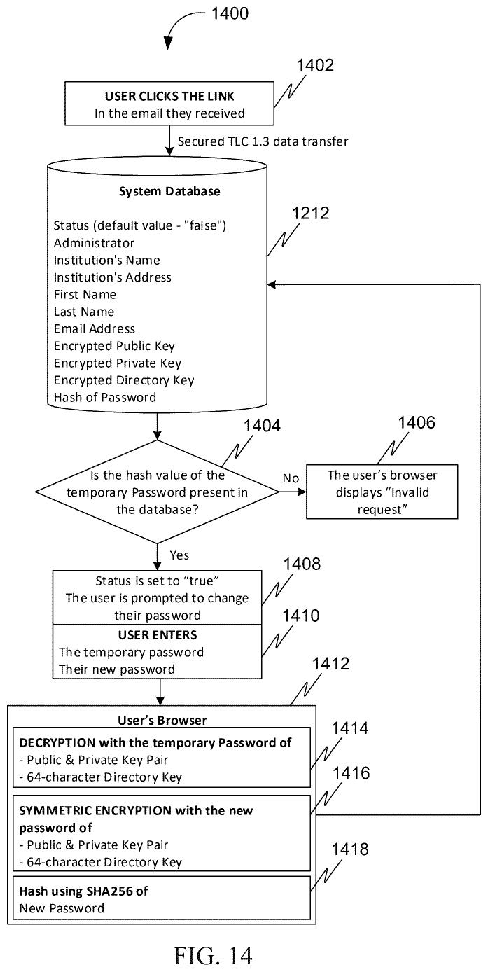

Further, the account registration process includes account creation for Additional Users: As shown in FIG. 10, the present disclosed system allows the administrator to create accounts for designated users. A temporary password is automatically generated, and an email is sent to the designated user to verify the email and activate the account. The process involves:
1. Password Generation: A random password is generated by the administrator's browser for the new user.
2. Encryption: the administrator's browser:
   a. Symmetrically encrypts the institution's private key and the directory key using the newly generated password.
   b. Generates a SHA256 hash of the password for verification and security purposes.
3. Data Transmission: The encrypted credentials, including the institution's public key and private key, the directory key, and the password hash, are securely transmitted to the servers for storage.
4. Data Transmission Security: All data transmissions between the browser and the server, including the transmission of encrypted keys, document data, and QR code images, are secured using Transport Layer Security (TLS 1.3). For more details on security, refer to the Security Protocols section.
5. Traceability and Audit Logs: The system incorporates a complete traceability mechanism via audit logs, allowing real-time tracking of all actions performed by users and administrators. Each critical operation-such as key generation, document certification, document verification, or QR code deactivation—is recorded with a precise timestamp. The audit logs include information about the user's identity, the nature of the operation, the time and date of the event, and the result of the action.
6. The audit logs enable proactive monitoring of the system to detect any suspicious or fraudulent activity. The audit logs are regularly analyzed by security algorithms to identify potential attack patterns or anomalies in user behavior. In case of a detected fraud attempt or unauthorized access, automatic alerts are generated and sent to administrators for rapid intervention. The logs are retained for a specified duration to ensure compliance with data security regulations and can be used for verification or investigation purposes if necessary.
7. Email Notification: An email is automatically sent to the designated user with account details and instructions on how to validate the account. The process of email confirmation is shown in FIG. 14, where the designated user confirms the email by clicking on the link and is prompted to change the password.

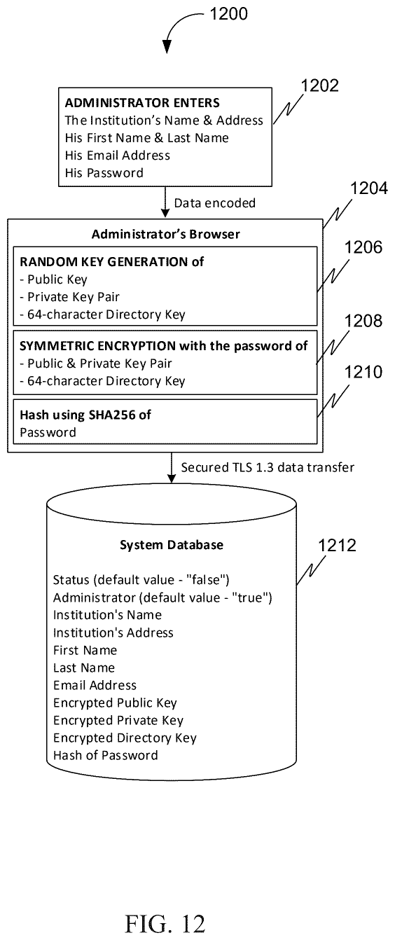

FIG. 12 illustrates a flow diagram of an account registration process for the facilitation of verification of a document, in accordance with some embodiments.

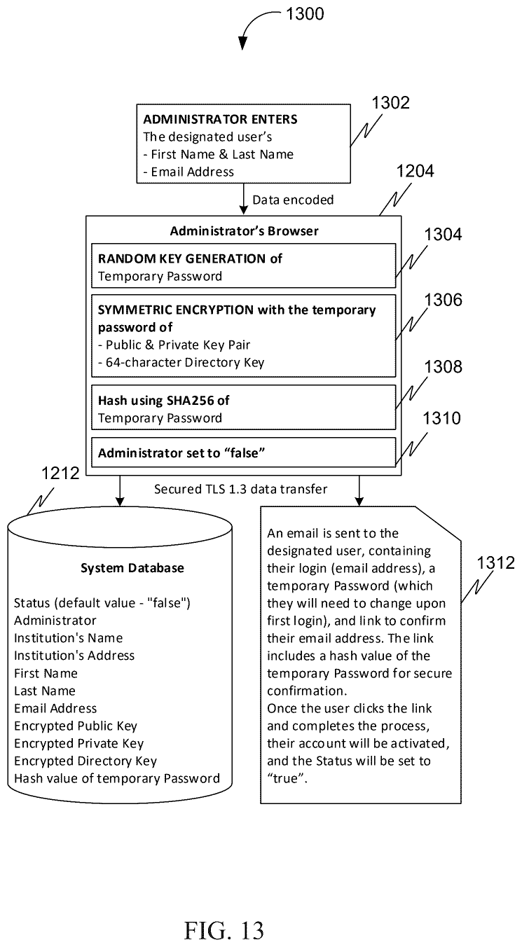

FIG. 13 illustrates a flow diagram of an account registration process for facilitation of verification of a document, in accordance with some embodiments.

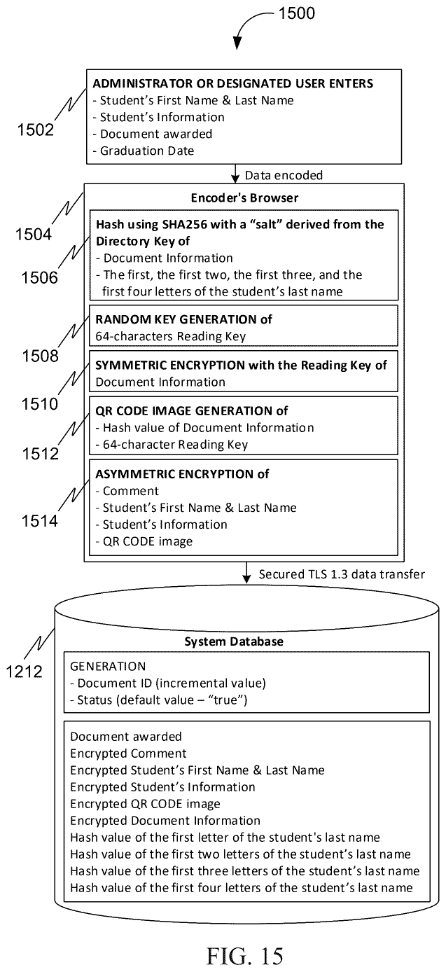

FIG. 15 illustrates a flow diagram of a certification process for facilitation of verification of a document, in accordance with some embodiments.

Accordingly, the process involves encrypting document data, generating SHA256 fingerprints, and generating a QR code for secure verification. In one embodiment, the administrator or a designated user manually certifies a document by entering the relevant information into the system. The following steps take place:
1. Hashing of Document Information: The system first generates a SHA256 hash of the document information. The hash acts as a digital fingerprint, ensuring the integrity of the document data and allowing verification against any modifications.
2. QR Code Generation and Symmetric Encryption:
   a. A 64-character Reading Key is randomly generated.
   b. The Reading Key is used to symmetrically encrypt the document information.
   c. The QR code contains two elements:
      i. The SHA256 hash of the document information.
      ii. The 64-character Reading Key (used to decrypt the document information).
   d. The document information stored in the system database is symmetrically encrypted with the Reading Key. The QR code holds the Reading Key to decrypt it, meaning that document information cannot be decrypted without access to the QR code.
3. Key Management: The key generation process uses a cryptographically secure random number generator (CSPRNG) to create 64-character symmetric keys, ensuring the security and unpredictability of the keys. Each key is unique for every document or certified document. Once generated, the key is used to encrypt the document's information, which is then stored in an encrypted format in the database. The keys are encrypted using the institution's public key before being stored in the database to secure the keys. The keys are not stored in plain text to prevent unauthorized access. After being used, the keys are deleted from the system's active memory and are only accessible through cryptographic processes during document verification. The mechanism ensures that each document has a distinct encryption key, securing the information throughout the lifecycle—from storage to verification. Additionally, audit logs record each key's generation and are used to ensure complete traceability of the process.
4. Storing Document Data in the System Database:
   a. The SHA256 hash of the document information is stored in the system database.
   b. The document information is symmetrically encrypted using the 64-character Reading Key and stored in the system database and ensures that only the users with access to the QR code (which contains the Reading Key) can retrieve and decrypt the document information.
   c. The image of the QR code is asymmetrically encrypted using the institution's public key and stored in the system database and ensures that only the institution, using the private key, can decrypt and retrieve the QR code when necessary.
   d. Additional student-related information is also asymmetrically encrypted using the institution's public key and stored in the system database, providing further protection of sensitive information.
5. Storage of SHA256 Hashes:
   a. In Directory1, the system stores the SHA256 hash with a salt derived from the directory key corresponding to the first letter of the graduate's last name.
   b. In Directory2, the SHA256 hash is stored with a salt derived from the directory key corresponding to the first two letters of the graduate's last name.
   c. In Directory3, the SHA256 hash is stored with a salt derived from the directory key corresponding to the first three letters of the graduate's last name.
   d. In Directory4, the SHA256 hash is stored with a salt derived from the directory key corresponding to the first four letters of the graduate's last name.
6. Data Transmission: The following data is transmitted to the servers:
   a. The asymmetrically encrypted image of the QR code.
   b. The SHA256 hash of the document information.
   c. A blob containing the document information, symmetrically encrypted using the randomly generated 64-character reading key.
7. Data Transmission Security: All data transmissions between the browser and the server, including the transmission of encrypted keys, document data, and QR code images, are secured using Transport Layer Security (TLS 1.3).

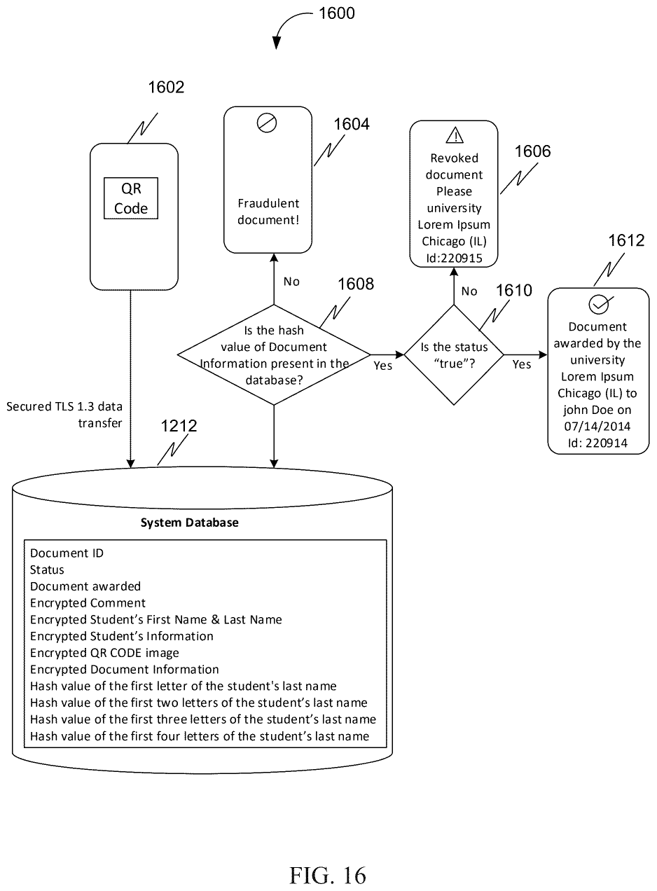

FIG. 16 illustrates a flow diagram of a verification process for facilitation of verification of a document, in accordance with some embodiments. Accordingly, the verification process of documents (Symmetric Decryption) includes the QR code verification process, where the mobile application verifies the authenticity of the document by retrieving the SHA256 hash from the system database. When a certified document's QR code is scanned, the application queries the database to retrieve the corresponding document's SHA256 hash. If the hash matches, the application symmetrically decrypts the document data from the system database using the reading key stored in the QR code. The document ID serves as a unique reference for tracking and verification purposes. For further details on how the database stores document information, refer to the “Database Role” section. If the document has been deactivated, the app will display a message advising the user to contact the institution with the document ID for further assistance:
1. Separation of Data: The application separates the SHA256 hash from the reading key embedded in the QR code.
2. Database Query: The application queries the database to check for the existence of the SHA256 hash in the “Documents” table.
3. Verification Process: If the SHA256 hash exists:
   a. Active Document: The application decrypts the content of the blob field and retrieves the document ID, which serves as a unique reference to the document.
   b. Inactive Document: If the document is no longer active, the application prompts the user to contact the institution's registrar, providing the document ID for further assistance.
   c. If the SHA256 hash does not exist: The document is identified as fraudulent.

Further, the verification process includes error scenarios and exception handling, which includes:
1. Hash Mismatch During Verification: If a mismatch occurs between the SHA256 hash in the QR code and the one stored in the database, the system immediately identifies the mismatch as a fraud attempt. The hash is used to query the database and retrieve the encrypted document information. If the hash does not match, the mismatch indicates that the QR code has been altered, or fraudulent data has been inserted. The mobile application notifies the user that the document is invalid, and verification is halted.
2. Attempt to Use a Deactivated QR Code: If a deactivated QR code is scanned, the application alerts the user that the associated document is no longer valid. The user is then prompted to contact the institution's registrar for further clarification. The registrar will confirm whether the document has been revoked or invalidated, effectively preventing the use of fraudulent documents.
3. Use of an Active QR Code on a Fake Diploma If a valid QR code is used on a fake diploma, the mobile application will display the authentic details of the originating institution and the document holder as stored in the database. The information will not match the fake diploma, revealing the fraudulent attempt through the discrepancies between the app's displayed data and the information on the document.

Further, the verification process includes handling corrupted QR codes and fraud prevention. The present disclosed system performs the following steps:
1. Corrupted or Damaged QR Codes: In the event that a QR code is damaged, corrupted, or unreadable, the user can request a new QR code from the system administrator or a designated user within the institution. Since the system retains the encrypted document data, a new QR code can be generated without altering the original document information and ensuring that even if the QR code is compromised, the integrity of the document remains intact, and verification can proceed with the new code.
2. Protection against Brute Force and Unauthorized Access: Each QR code is generated from a unique combination of a 64-character reading key and a SHA256 hash, which corresponds to the diploma's fingerprint stored in the system's secure database. The likelihood of successfully guessing the combination is exceedingly low, virtually impossible for unauthorized users to generate a valid QR code through brute force attacks. Additionally, the system incorporates robust protection mechanisms that detect and mitigate brute force attempts. If multiple failed verification attempts are detected, the system temporarily suspends access, alerts the administrator, and flags the attempt as suspicious, thereby safeguarding against unauthorized access.

Further, the verification process includes handling fraud (Deactivation Process), wherein, in cases of fraud, misconduct, or misuse of a certified document or document, the administrator or designated user can immediately deactivate the associated QR code by marking the document's status as “false”. The deactivation is propagated in real-time across the system. Anyone scanning the deactivated QR code via the mobile application will receive an alert, indicating that the document is no longer valid and advising the user to contact the institution for further details. The mechanism ensures that fraudulent documents cannot be reused after detection, providing enhanced security for institutions and verifiers. Once a diploma's status is set to “false”, the associated QR code becomes invalid. Any attempt to scan the code will notify the user that the document is no longer valid. The user will be prompted to contact the institution directly using the document ID to obtain more information about the diploma's current status. Additionally, individuals who have previously scanned the QR code will be alerted in real-time via the mobile application that the document is now invalid:
1. Blob: A blob refers to a collection of binary data (such as encrypted document information) stored in the system's database. The blob contains all relevant document data, ensuring secure storage. Access and decryption of the data are restricted to the system's cryptographic processes.
2. Security Protocols: All data transmissions between the browser and server, including encrypted keys, document data, and QR code images, are secured using Transport Layer Security (TLS) 1.3. The protocol ensures that all transmitted data remains encrypted, protecting the data from unauthorized access or interception. The system applies symmetric encryption for securely storing document data and asymmetric encryption for securely transmitting QR codes, providing multi-layer protection for sensitive information.
3. Document ID: The system generates a unique Document ID in the database for tracking and verification purposes.

Further, the present disclosed system is capable of upgrading encryption technologies and maintaining backward compatibility: As cryptographic techniques evolve, upgrading encryption algorithms is critical to maintaining security and resilience against modern threats. The present disclosed system employs the following steps to ensure upgrading encryption technologies and maintaining backward compatibility:
1. Monitoring Cryptographic Advancements: The system continuously monitors cryptographic developments, including vulnerabilities in current algorithms (e.g., SHA256, AES-256). If an algorithm is found to be obsolete or insecure, the platform initiates an upgrade process to adopt advanced protocols, such as SHA3-256 or Elliptic Curve Cryptography (ECC).
2. Transitioning to New Encryption Algorithms: Upon selecting a new cryptographic standard, the following steps will be implemented to ensure a seamless transition:
   a. Generation of New QR Codes: New documents will utilize the updated cryptographic methods, ensuring enhanced security.
   b. Encryption of New Data: Newly certified documents will be encrypted using the new algorithm and stored securely under the updated protocol.
3. Impact on Existing QR Codes: Existing QR codes generated using older encryption algorithms will remain valid. The system will maintain a dual-decryption capability, allowing the verification of documents encrypted under the previous methods. Specifically:
   a. Dual Encryption Support: The verification application will identify the encryption algorithm (e.g., SHA256 for older codes, ECC for newer codes) and apply the appropriate decryption method.
   b. Backward Compatibility: Metadata will be stored for each document, indicating the encryption method used, thus maintaining backward compatibility during verification.
4. Phased Upgrade for Institutions: For institutions managing large volumes of existing QR codes, a phased upgrade option will be available. The option allows re-certification and re-issuance of documents under the updated cryptographic standard, providing long-term security without requiring immediate re-certification of all past documents.
   a. Deactivation and Re-Issuance Protocol: For institutions seeking to upgrade all previously issued QR codes, a bulk deactivation and re-issuance process can be initiated.
   b. Deactivation of Old QR Codes: Existing codes will be systematically deactivated as new ones are generated and issued.
5. Re-Issuance of New QR Codes: New QR codes using the upgraded encryption methods will be generated for all previously certified documents. Institutions can distribute the new codes to document holders to ensure continued document security.
6. User Notification: Institutions and users will be notified in advance of any system-wide cryptographic upgrades. Instructions on managing the transition, including verifying older documents and generating new QR codes, will be provided.

Further, the present disclosed system also includes lifespan and secure handling of decrypted keys. Managing the lifespan of private and public keys is a critical aspect of cryptographic security in the system. The present disclosed system introduces methods for securely managing the keys, minimizing the risk of data compromise while ensuring optimal security during user sessions.
1. Key Lifespan and Removal after Logout: Keys are decrypted and loaded into memory only for the duration of the session. Once the session ends, keys are automatically deleted, ensuring that the keys remain inaccessible and minimizing the risk of memory-based attacks or unauthorized access.
2. Automatic Session Expiration: If the user does not explicitly log out, the system implements automatic session expiration after a predefined period of inactivity. Upon expiration, all keys in memory are deleted, and the session is invalidated, preventing potential exploitation.
3. Secure Temporary Key Storage: During an active session, private and public keys may be temporarily re-encrypted using an ephemeral key generated by the browser. The key is task-specific and destroyed upon completion, providing an additional layer of protection.
4. Memory Protection and Isolation: The system includes memory protection mechanisms to prevent key extraction through local attacks. Sensitive processes are confined to secure environments, such as secure enclaves, limiting the risk of memory-based attacks.
5. Efficiency of Cryptographic Operations: Key management is optimized to ensure minimal impact on browser or device performance while maintaining maximum security.
6. Proactive Session and Key Management: The system includes active monitoring to detect unusual session activity. If tampering is detected, the system immediately deletes the keys and terminates the session.

Further, the system integrates several security layers to protect against malicious attacks and safeguard data integrity. The measures include:
1. Man-in-the-Middle (MITM) Attack Protection: All client-server communications are encrypted using TLS 1.3, preventing interception. Digital certificates issued by recognized certification authorities authenticate servers and guarantee the integrity of communications.
2. Web Application Firewall (WAF): A WAF is deployed to monitor and filter incoming HTTP requests, detecting and blocking attacks such as SQL injections, cross-site scripting (XSS), and intrusion attempts.
3. Multi-Factor Authentication (MFA): The system implements multi-factor authentication to secure administrator accounts, adding an extra layer of protection by requiring a second verification method, such as an authentication app, in addition to a password.
4. Brute Force Attack Prevention: If multiple failed login attempts are detected, access is temporarily suspended, and the administrator is notified.
5. Event Logging and Monitoring: Comprehensive audit logs track all actions performed by users, including login attempts, key generation, and document verifications. The logs are regularly analyzed to detect suspicious activity or vulnerabilities.

Further, some exemplary embodiments include:
1. Embodiment 1: Automatic Certification Process: In one embodiment, the certification process is fully automated through an API. The API retrieves the relevant document data from the institution's records and performs the certification steps autonomously, without requiring manual input from an administrator or designated user. The API replicates the same cryptographic processes, including the generation of a 64-character reading key, encryption of the document data, creation of a QR code, and secure storage of the encrypted data within the database. The API-based certification enables institutions to automate the entire process, reducing manual intervention and facilitating the efficient certification of large volumes of diplomas. The API also ensures that the SHA256 hash is created and associated with the diploma, allowing institutions to scale the certification process securely and efficiently.
2. Embodiment 2: Contract Certification Process: In another embodiment, the system can be used to certify and verify the authenticity of contracts. The process mirrors that of document certification:
   a. The contract is symmetrically encrypted using a 64-character reading key
   b. A unique QR code is generated, which contains both the SHA256 hash of the contract data and the reading key.
   c. The system securely stores the encrypted contract and the QR code image in the database, while enabling contract verification through a dedicated mobile application, and ensures that businesses can secure critical agreements, guaranteeing that the critical agreements remain tamper-proof and easily verifiable.
3. Embodiment 3: Powers of Attorney Certification Process: The system can also be applied to certify powers of attorney. In the embodiment:
   a. The details of the power of attorney are encrypted using symmetric cryptography, and a unique reading key is generated.
   b. The QR code generated for the power of attorney contains both the SHA256 hash of the document and the reading key for decryption.
   c. The encrypted document and the associated QR code are securely stored in the system's database and allow for secure verification, ensuring the document's integrity and authenticity. In the event of legal disputes or the need for validation, powers of attorney can be quickly verified through the QR code system.
4. Embodiment 4: Email Certification Process: In another embodiment, the system can be applied to certify email communications, ensuring the integrity and authenticity of correspondence:
   a. The content of the email is hashed using SHA256 and encrypted with a 64-character symmetric key.
   b. A QR code is generated, containing both the hash and the reading key, allowing the recipient or a third party to verify the authenticity of the email.
   c. The email and the QR code are stored securely in the system, with all data encrypted and an option for future verification.

Further, the present disclosed system can be implemented with various technical modifications and enhancements without deviating from the core principles of secure document certification, encryption, verification, and real-time alerts. Below are potential technical variants that can be adapted based on specific needs or technological advancements:
1. Alternative Hashing Algorithms: While the system primarily utilizes the SHA256 hashing algorithm, alternative cryptographic hash functions such as SHA3-256 or BLAKE2 may be employed depending on an institution's security requirements or industry standards. The algorithms ensure data integrity and prevent tampering by generating unique digital fingerprints for documents.
   a. SHA3-256 offers enhanced protection against advanced cryptographic attacks and is ideal for sectors such as healthcare or financial services, where higher security is crucial. SHA3-256 could be used in government-issued certificates where the highest level of security is required.
   b. BLAKE2 provides high security with superior performance and is suitable for environments that prioritize speed and efficiency, such as mobile applications or low-latency systems. BLAKE2 could be implemented in real-time data verification systems, where rapid processing is a priority.
2. Alternative Encryption Protocols: The system currently uses AES-256 and RSA for symmetric and asymmetric encryption. However, other protocols like Elliptic Curve Cryptography (ECC) can be implemented to enhance efficiency, particularly for mobile or low-power devices. ECC provides strong security with smaller key sizes, which is beneficial in scenarios that require faster processing or lower computational overhead. For example, in an IoT-based document verification system for smart cities, ECC could reduce computational load and save bandwidth while maintaining secure communications.
3. Modular Authentication Options: Beyond traditional multi-factor authentication (MFA), the system can incorporate biometric authentication methods, such as fingerprint or facial recognition, to enhance security in high-risk environments and would be particularly beneficial in sectors like financial services or legal fields, where access to sensitive information requires additional verification layers. For example, a legal document verification system could integrate biometric MFA to ensure that only authorized personnel can access sensitive contracts or court orders.
4. Flexible QR Code Formats: While the system uses QR codes for document verification, alternative barcode formats such as Data Matrix or Aztec Code can be employed based on specific requirements. Data Matrix is commonly used in industries like logistics or pharmaceuticals, where smaller labels are required, while Aztec codes perform better in low-light or low-resolution environments. For example, in manufacturing supply chains, Data Matrix codes could be used for product compliance certificates, allowing smaller secure labels that can be scanned in warehouse environments.
5. Cloud vs. On-Premise Deployment: The system is designed for storing encrypted document data in secure databases but can be adapted for different deployment models. Institutions can choose cloud-based hosting for scalability and accessibility or opt for on premise deployment to maintain stricter control over data security and regulatory compliance. The choice of infrastructure does not impact the core cryptographic processes but offers flexibility in system management and maintenance.
6. API Extensions for Integration: The system's API can be extended to integrate with external platforms or databases. For example, the system could connect to Human Resource Management Systems (HRMS) to verify employee credentials during onboarding or integrate with national identification databases or certificate authorities for real-time document legitimacy verification.
7. Enhanced Audit Log Capabilities: While the system currently logs key actions such as document certification, verification, and key generation, advanced logging features could be introduced and could include real-time analytics and anomaly detection to identify potential security breaches or suspicious activity, further strengthening the system's security through proactive monitoring.
8. Support for Multiple Document Types: Although the system is designed for documents, contracts, and powers of attorney, and can be extended to support other document types such as intellectual property filings (patents, trademarks), government-issued certificates, or financial documents (invoices, tax filings). Each document type may have specific encryption, storage, or verification requirements that the system can accommodate through custom configurations.

Further, the following section outlines the key components and processes of the disclosed system, including the overall system for secure document certification, the cryptographic processes, and specific methods employed for real-time fraud prevention, detection, and verification:
1. System-Level: The present disclosed system for managing, certifying, and verifying documents using integrated cryptographic techniques and dynamic, real-time QR code-based verification processes is to be protected as a whole, including the system's ability to encrypt document data, generate unique QR codes, and store encrypted information in a secure database. The real-time management of QR codes (including the generation, deactivation, and verification) is critical. The QR codes are readable exclusively via a dedicated mobile application, ensuring that only authorized users can verify documents securely, preventing tampering or fraudulent use.
2. Method-Level:
   a. Encrypting document data using SHA256 hashing and symmetric/asymmetric encryption for secure certification and storage.
   b. Generating QR codes that encapsulate document hashes and reading keys, with unique encryption methods to ensure integrity.
   c. Verifying documents in real-time by querying the system's database and decrypting document data using keys embedded within the QR code.
   d. Dynamic fraud detection and prevention, where fraudulent documents are flagged, QR codes are deactivated in real-time, and verifiers are instantly notified of the invalidation.
   e. The system's application extends to a non-exhaustive list of document types, including but not limited to press releases, contracts, powers of attorney, email content, and other secure documents, offering broad applicability across industries.
3. Component-Specific:
   a. QR Code Generation, Verification, and Deactivation: A unique QR code system that facilitates real-time generation, secure verification, and immediate deactivation in cases of fraud or misuse. The system's ability to immediately disable QR codes and notify previous verifiers (via mobile app) is a core element of protection.
   b. Cryptographic Integration: The system employs SHA256 hashing, AES-256 encryption, and other cryptographic techniques to ensure document integrity throughout its lifecycle from creation to verification, providing an unprecedented level of security.
   c. Traceability of the Mobile Application's Origin: The origin of the dedicated mobile application for reading the QR codes is traceable to the source through app store verification and ensures that only the authentic app, developed and approved through recognized app store processes, can be used, preventing unauthorized or fraudulent apps from accessing the system.
   d. Confidentiality of Stored Information Without Third-Party Trust: The system ensures the confidentiality of all stored document data through advanced encryption techniques, without the need for reliance on a trusted third party. All document data, including associated metadata and QR codes, is encrypted both at rest and during transmission, ensuring that only authorized parties with the appropriate decryption keys can access or modify the information. The confidentiality is maintained autonomously by the system, providing an additional safeguard against unauthorized access or tampering throughout the entire document lifecycle.
4. Scalability and Future-Proofing: The present disclosed system's scalability to handle high-volume certification and the ability to upgrade cryptographic protocols while maintaining backward compatibility is a core feature. And includes both cloud-based and on-premise deployment models, allowing the system to evolve and adapt without compromising the integrity of document certification and verification processes.
5. Additional Scope:
   a. Scope extends beyond current cryptographic techniques, such as SHA256 and AES-256 encryption, to cover any future cryptographic protocols that may be integrated into the system and include but is not limited to SHA3-256, Elliptic Curve Cryptography (ECC), and other evolving security standards necessary to meet new threats.
   b. The system's architecture is scalable and adaptable, capable of handling increasing volumes of documents and supporting the integration of new cryptographic techniques or enhanced security measures. The adaptability ensures the system's longevity and resilience against evolving threats.
6. Real-Time Notifications and QR Code Management:
   a. The disclosed system comprises real-time notification capabilities. In the event of fraud or document invalidation, prior verifiers who used the dedicated mobile application to scan the QR code will be notified in real time. The secure feedback loop prevents further reliance on compromised documents, a feature that is absent in traditional, blockchain-based, and static QR code verification systems.
   b. The dynamic management of QR codes, including the generation, real-time verification, and deactivation, is a core area of protection, challenging competitors to bypass the security measures in place.
7. API Extensions for External System Integration:
   a. The system's ability to integrate via APIs with external platforms, such as Human Resource Management Systems (HRMS), national identification databases, and other secure document management systems, is included in the scope. The extension allows the disclosed system to verify credentials during onboarding or confirm the legitimacy of documents in real time, ensuring broader applicability across industries and sectors.

The present disclosed system offers a robust system for the secure management, certification, and verification of critical documents, including academic documents, contracts, powers of attorney, and digital communications. By employing advanced cryptographic techniques such as a combination of symmetric and asymmetric encryption, along with SHA256 hashing, the system ensures the confidentiality and authenticity of sensitive data without reliance on third-party verification systems. The decentralized approach addresses vulnerabilities inherent in traditional systems, significantly enhancing both security and control.

The present disclosed system provides substantial improvements in security and efficiency. Through the use of unique QR codes for each certified document, institutions can manage, certify, and verify documents digitally and in real time, reducing the risk of fraud or misuse. Importantly, the QR codes can only be read by a dedicated mobile application for smartphones and tablets, ensuring that only authorized users can verify documents. Unlike web-based systems, where QR code redirection can be vulnerable to malicious interference, a mobile application downloaded from an app store allows the origin of the verification system to be traced, further ensuring trust and security in the document verification process. All sensitive data is stored securely within a protected database, and access is restricted to authorized users via cryptographic processes during the verification process, ensuring the highest level of data protection. One key innovation is the ability to deactivate QR codes in cases of fraud or misconduct. The dynamic fraud-prevention mechanism allows administrators to swiftly invalidate compromised documents, ensuring that the compromised documents cannot be reused. Additionally, the system's real-time fraud detection and notification features further improve the user experience by providing immediate alerts to the prior verifiers who have previously verified the document—an innovation absent from conventional systems.

The combination of real-time QR code deactivation, instant notifications to prior verifiers, and advanced cryptographic security creates an unexpectedly superior solution for preventing document fraud and facilitating verification. While the features are known independently, the integration in the system produces a synergistic effect that is non-obvious and unpredictable to users skilled in the art:
1. Proactive Fraud Prevention: The system prevents ongoing misuse of fraudulent documents by allowing real-time deactivation of QR codes and providing instant feedback to verifiers. Traditional systems lack real-time adaptability.
2. Instant Notifications: The system's ability to notify prior verifiers when a document becomes compromised ensures that all stakeholders are informed, a feature that is absent from existing solutions.
3. Dynamic Cryptographic Integration: Beyond encryption, the system manages documents dynamically throughout the lifecycle, offering an unprecedented level of security and control.
4. Confidentiality and Data Integrity: In addition to dynamic cryptographic integration, the system guarantees that all stored documents and related data remain confidential and protected from unauthorized access. By securing data at rest and during transmission, the system ensures privacy compliance and safeguards sensitive information throughout the document's lifecycle.

The unexpected synergy of the features creates a solution that is significantly more effective than existing alternatives.

The present disclosed system is designed to scale seamlessly and is adaptable for both small organizations and large institutions that manage high volumes of certifications and verifications. The system can handle millions of certifications without compromising performance or security, and versatility allows the system to serve various sectors, including academia, legal, healthcare, and government, ensuring that the system meets the evolving needs of organizations worldwide. Moreover, the system's use of advanced cryptographic techniques and the ability to integrate future encryption protocols ensures that the system remains secure and resilient against evolving technological threats. The adaptability makes the system a future-proof solution for the long-term management of sensitive documents.

The present disclosed system revolutionizes document verification by combining cryptographic security, real-time fraud prevention, dynamic QR code management, and strict data confidentiality, resulting in a non-obvious and superior solution. The QR codes are securely verifiable only through a dedicated mobile application, whose origin can be traced through app store downloads, unlike website-based systems that can be easily spoofed. The unexpected synergy of the features results in a scalable, secure, and efficient platform suitable for academic, legal, and business applications. The adaptability, innovative fraud-prevention mechanisms, and future-proof architecture position as a superior alternative to existing systems, providing organizations with a powerful tool to safeguard the integrity of the documentation processes.

In some embodiments, the system may generate and manage dynamic encrypted QR codes that are readable exclusively by a dedicated mobile application. The technical problem addressed is the susceptibility of static QR codes to redirection attacks and forgery. Traditional QR codes encode fixed URLs, which can be replaced or redirected by malicious actors, thereby compromising document authenticity. The improvement arises from integrating real-time cryptographic binding between the QR code and a server-stored encrypted dataset. In one implementation, the system may employ a cryptographically secure random number generator to produce a 64-character symmetric key. The key may be embedded in an encrypted QR code, ensuring that each verification request requires an exact cryptographic match with the system database. The system may dynamically update or deactivate QR codes when fraud is detected, thereby ensuring the security of both document and verification pathways. The feature specifically improves mobile cryptographic authentication technology, enabling secure and revocable identity-linked QR code verification in real time.

Further, according to some embodiments, the following aspects are also provided herein:
1. A method of verifying a document, comprising: receiving, via a communication device, at least one access request from at least one first user device associated with at least one first user, the access request comprising at least one first hash value and at least one encryption key; retrieving, via a storage device, at least one second hash value from at least one database; analyzing, via a processing device, the at least one first hash value and the at least one second hash value; generating, via the processing device, at least one verification result based on the analysis; and transmitting, via the communication device, the verification result to the first user device.
2. The method of aspect 1, wherein the document comprises any digital or digitized record, including but not limited to documents certificates, attestations, licenses, contracts, powers of attorney, administrative documents, or email messages.
3. The method of aspect 1, wherein the method comprises generating a dynamic encrypted QR code associated with the document, the QR code comprises the first hash value and the encryption key.
4. The method of aspect 1, wherein the QR code is only decryptable using a dedicated mobile application downloadable from a verified app store.
5. The method of aspect 1, wherein the mobile application is configured to: scan the encrypted QR code; decrypt the hash and the encryption key; and trigger the access request to the server for verification.
6. The method of aspect 1, wherein the method comprises deactivating the QR code in real time upon detection of fraudulent activity.
7. The method of aspect 1, wherein the method comprises generating and transmitting, to one or more previous verifiers, a notification indicating that the document has been invalidated.
8. A system for verifying a document, comprising: a communication device configured to receive access requests comprising at least one hash value and at least one encryption key; a processing device configured to compare the hash value to at least one stored hash value; a storage device configured to store encrypted document data and corresponding hash values; wherein the processing device is further configured to generate verification results and transmit them to a user device.
9. The system of aspect 8, wherein the system comprises a QR code generator configured to create encrypted QR codes linked to the document.
10. The system of aspect 8, wherein the QR code includes a salted SHA256 hash and a symmetric 64-character encryption key.
11. The system of aspect 8, wherein the system comprises a mobile application that decrypts the QR code and interfaces with the communication device to initiate verification.
12. The system of aspect 8, wherein the processing device is configured to deactivate the QR code in real time.
13. The system of aspect 8, wherein the communication device is further configured to transmit deactivation alerts to previous verifiers.
14. A non-transitory computer-readable medium storing instructions that, when executed by a processor, cause the processor to: receive a verification request comprising a hash and an encryption key; retrieve a stored hash from a database; compare the received hash and the stored hash; return a verification result to a requesting device; and optionally trigger deactivation and alert functions if fraud is detected.

In some embodiments, the dynamic cryptographic linkage may be implemented using an asymmetric key pair, wherein the QR code is encrypted using a public key while the corresponding private key is stored within a secure enclave of the verification server. Verification may occur through a challenge-response protocol, ensuring that no static data is ever exposed to the user or attacker.

In some embodiments, the system may include a real-time fraud detection module configured to monitor document verification events and instantly propagate notifications to prior verifiers when fraudulent activity is detected. The technical problem addressed is the lack of retroactive fraud awareness in traditional systems-once a document is verified, prior verifiers remain unaware of subsequent invalidation. The system improves real-time communication and event-driven alert systems by incorporating a push-notification architecture that interfaces with the mobile verification app. Each verification instance may generate a unique session identifier logged in an audit ledger. Upon deactivation of a QR code or detection of a hash mismatch, the system may automatically identify and notify all devices associated with the session identifiers through a secure message queue protocol, such as MQTT or AMQP. The implementation may employ encrypted multicast transmissions to prevent message interception. The combination of proactive alerting and cryptographic integrity checks provides an improvement in secure distributed verification networks, allowing document verifiers to maintain continuous trust chains across the verification lifecycle.

In some embodiments, the disclosed system may implement a dual-layer encryption architecture combining symmetric and asymmetric cryptography across all document transactions. The technical problem addressed is the exposure of intermediate plaintext during encryption-decryption sequences in traditional verification systems. The system improves cryptographic lifecycle management technologies by ensuring that document data is encrypted at the point of creation, remains encrypted during transmission and storage, and is decrypted only within secure environments during verification. Each document may be associated with a unique symmetric key that is further encrypted using the institution's asymmetric key pair.

In one implementation, the system may use AES-256 for symmetric encryption and Elliptic Curve Cryptography (ECC) for public-key operations. To enhance performance, the decryption key may only exist in volatile memory during verification and may be automatically destroyed upon session termination, preventing memory-based exploits. The architecture results in a tangible improvement in data-at-rest and in-transit confidentiality systems, reducing attack surfaces in multi-tenant environments such as academic or governmental verification portals.

In some embodiments, the system may use an app-store-verified mobile application as the exclusive verification medium. The technical problem solved is the spoofing and redirection vulnerabilities of web-based verification systems that allow attackers to clone or fake verification portals. The system improves mobile software trust architectures by leveraging digital code-signing certificates and verified developer identities maintained by recognized app stores. The verification app may perform checksum validation on the executable code and may use attestation APIs to confirm the authenticity at runtime. In one implementation, the application may periodically retrieve the cryptographic signature hash from the app store's verification service and compare with the locally stored signature to ensure code integrity. The feature ensures that only authentic, untampered applications can decrypt QR codes or communicate with the backend server, representing a significant advancement in trusted mobile verification technologies.

In some embodiments, the system may include a tamper-resistant propagation layer that ensures deactivation commands cannot be delayed, intercepted, or spoofed. The technical problem addressed is the latency and vulnerability of traditional revocation systems, where fraudulent credentials may remain usable until central updates propagate. The system improves revocation and distributed synchronization technologies by using a blockchain-inspired timestamp ledger or a distributed hash table (DHT) to store deactivation events. Each verification attempt may query both the central database and a lightweight peer node cache to ensure deactivation status consistency. In another embodiment, a secure checksum verification algorithm may be applied to the deactivation record, ensuring immutability. The multi-layered propagation system enhances real-time credential invalidation technology, providing immediate revocation capability without service disruption.

In some embodiments, the system may be designed to dynamically upgrade cryptographic algorithms as standards evolve while maintaining backward compatibility. The technical problem addressed is the difficulty of transitioning legacy cryptographic systems to newer standards without breaking existing encrypted assets. The improvement lies in the introduction of a dual-decryption compatibility engine that may store metadata identifying the encryption algorithm (e.g., SHA256, SHA3-256, ECC). During verification, the system may automatically select the appropriate decryption protocol. Institutions may gradually migrate documents by generating new encrypted versions while keeping the older ones verifiable. The innovation improves cryptographic adaptability and forward-compatibility technologies, ensuring long-term system resilience without compromising data security.

In some embodiments, the system may implement ephemeral key storage and automatic key destruction mechanisms. The technical problem addressed is the persistence of private keys in memory or storage after use, exposing the keys to side-channel or memory dump attacks. The system improves session-based cryptographic security technologies by loading keys into protected memory regions only during active user sessions. When the session expires, all keys may be erased and memory wiped using zeroization techniques compliant with FIPS 140-3 standards. In further embodiments, the browser or app may re-encrypt temporary keys with a time-limited ephemeral session key generated locally and destroyed after use and provide a measurable improvement in volatile key protection mechanisms used in modern secure communication systems.

In some embodiments, the system may include a machine learning-based fraud detection engine. The technical problem addressed is the limited ability of rule-based systems to predict or prevent evolving fraud patterns. The system may utilize neural networks trained on audit log data to detect anomalies in access frequency, geolocation, or device identity. The model may use unsupervised learning techniques such as autoencoders to identify outliers, prompting automated QR code suspension or administrator alerts. The feature enhances cybersecurity intelligence technology, allowing predictive rather than reactive fraud prevention.

In some embodiments, the system may integrate post-quantum cryptographic algorithms such as lattice-based or hash-based encryption to resist decryption by quantum computers. The technical problem addressed is the vulnerability of RSA and ECC algorithms to Shor's algorithm in future quantum computing environments. An implementation may employ CRYSTALS-Kyber for key encapsulation and CRYSTALS-Dilithium for digital signatures. The system may further maintain dual encryption-quantum-safe for new documents and conventional for backward compatibility. The feature improves quantum-resilient encryption technology, ensuring future-proof document verification.

In some embodiments, the system may incorporate secure multi-party computation (MPC) to enable joint verification across institutions without revealing underlying data. The technical problem addressed is inter-institutional collaboration without breaching confidentiality. Multiple institutions may hold partial decryption keys; verification may require consensus among the partial decryption keys. The system may utilize threshold cryptography, where at least n-of-m institutions must approve before the document is decrypted and provides a major enhancement to distributed cryptographic trust frameworks, enabling cooperative verification networks across borders or domains. In some embodiments, the system may implement a zero-knowledge proof verification layer allowing proof of authenticity without revealing underlying document data. The technical problem addressed is privacy leakage during verification, where even legitimate access reveals document metadata. The ZKP layer may use zk-SNARKs or Bulletproof protocols to confirm that a valid hash-key pair exists in the database without exposing the plaintext, ensuring verification authenticity while maintaining total data confidentiality, enhancing privacy-preserving verification technologies.

In some embodiments, the system may optionally integrate a private blockchain ledger to record cryptographic hashes of verification and certification events. The technical problem addressed is the potential alteration or deletion of audit logs in centralized systems. Each event, including document creation, key generation, and verification, may be timestamped and immutably stored in the ledger. The blockchain may be implemented using Hyperledger Fabric or similar permissioned frameworks, improving tamper-evident event logging technologies.

In some embodiments, the system may incorporate partially or fully homomorphic encryption to process encrypted data without decryption. Addressing the technical problem of data exposure during processing or analytics. For instance, verification frequency or usage statistics may be computed directly on encrypted datasets using schemes such as BFV or CKKS, provide improvements in confidential computation technologies, allowing analytics on sensitive data while preserving encryption integrity. In some embodiments, verification computations may be offloaded to edge nodes near the user's location to reduce latency and network dependency. The technical problem addressed is verification delay during high traffic or low-connectivity scenarios. Edge servers may locally store a cache of encrypted verification tokens and validation metadata synchronized periodically with the central server. The approach improves edge-based cryptographic verification technology, ensuring near-instantaneous verification even under constrained connectivity.

In some embodiments, the mobile application may employ biometric authentication, such as fingerprint or facial recognition as a second factor before permitting QR code decryption. The technical problem addressed is unauthorized access to verification functions on compromised devices. The biometric data may be locally matched using secure enclave hardware (e.g., ARM TrustZone or Apple Secure Enclave) and never transmitted externally, and improves biometric-secured cryptographic access control technologies, enhancing both convenience and security for verifiers.

In some embodiments, the system may include differential privacy algorithms to allow institutions to analyze verification trends without exposing individual document data. Randomized noise may be introduced during aggregation to ensure that statistical results remain accurate without compromising privacy and improves privacy-preserving data analytics technology, enabling safe system monitoring and usage optimization.

In some embodiments, the system may integrate W3C-compliant Decentralized Identifiers, allowing institutions and users to manage verifiable credentials independently. Each document may be bound to a DID record on a distributed ledger, ensuring verifiability without central authority dependency. The feature improves self-sovereign identity technology, aligning the disclosed system with emerging standards for decentralized trust ecosystems.

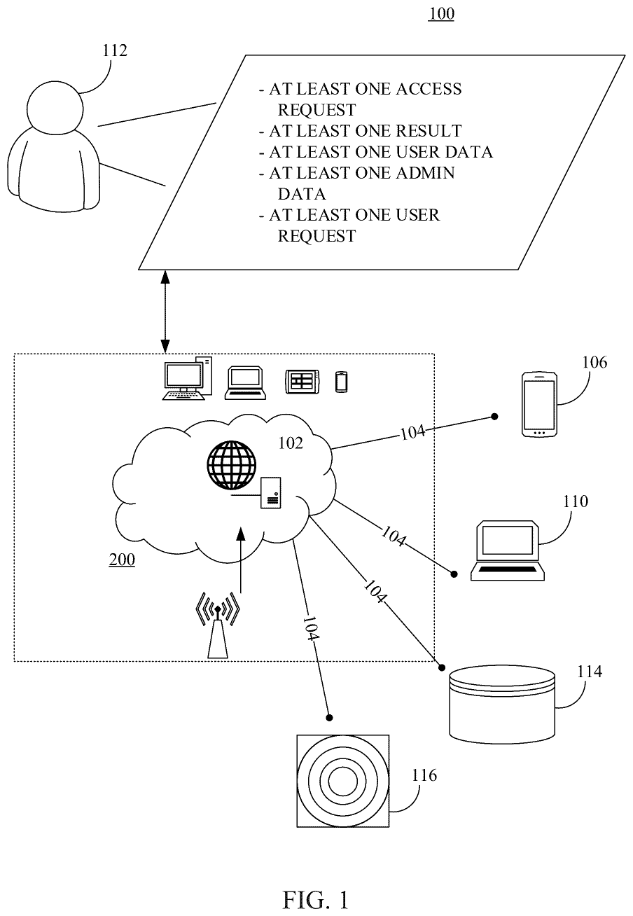

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

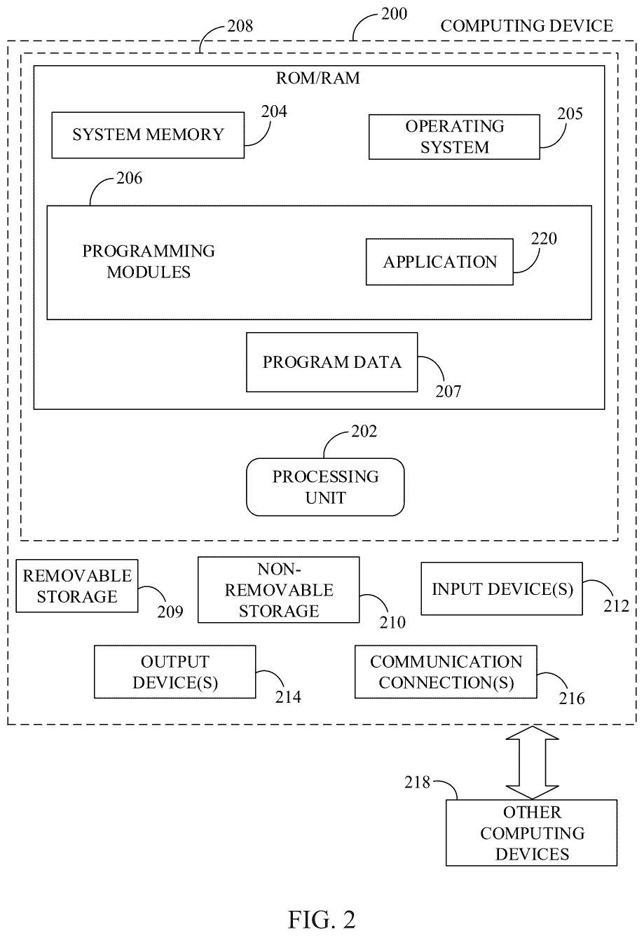

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208. Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media.

Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

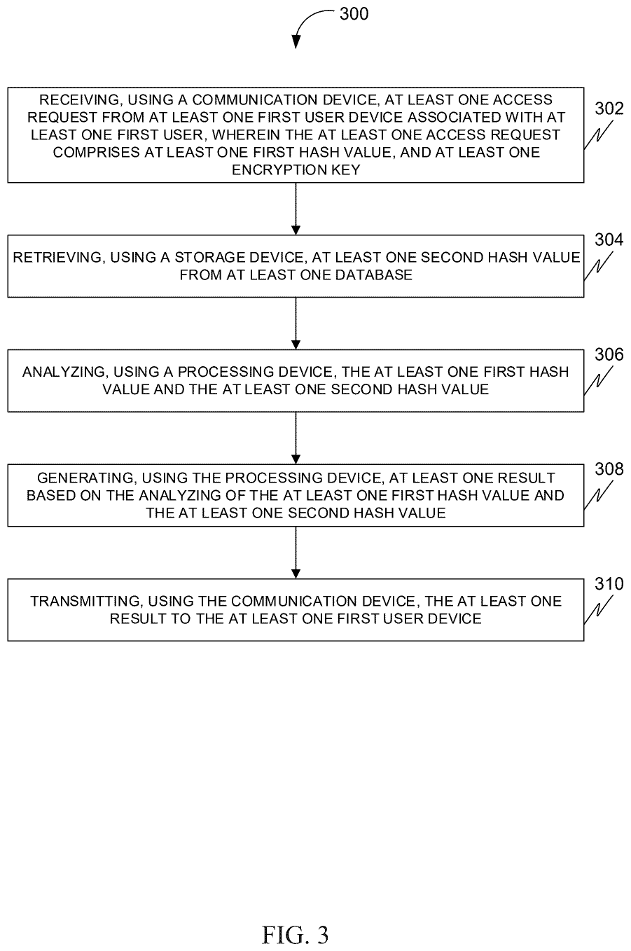

FIG. 3 illustrates a flowchart of a method 300 of facilitating document validation, in accordance with some embodiments. Accordingly, the method 300 may include a step 302 of receiving, using a communication device 1002, one or more access requests from one or more first user devices associated with one or more first users. Further, the one or more access requests include one or more first hash values, and one or more encryption keys. Further, the method 300 may include a step 304 of retrieving, using a storage device 1006, one or more second hash values from one or more databases. Further, the method 300 may include a step 306 of analyzing, using a processing device 1004, the one or more first hash values and the one or more second hash values. Further, the method 300 may include a step 308 of generating, using the processing device 1004, one or more results based on the analyzing of the one or more first hash values and the one or more second hash values. Further, the method 300 may include a step 310 of transmitting, using the communication device 1002, the one or more results to the one or more first user devices.

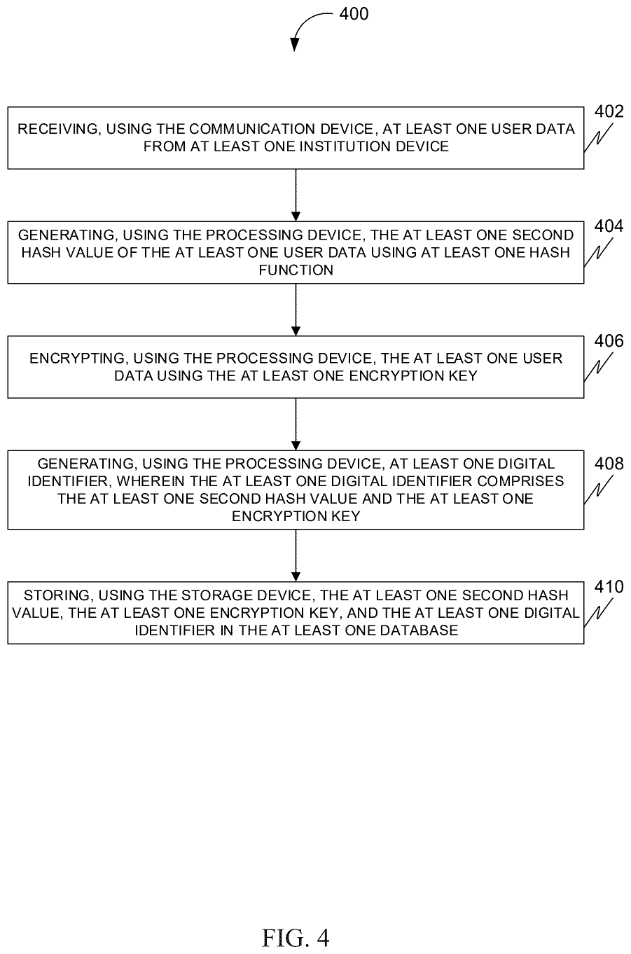

FIG. 4 illustrates a flowchart of a method 400 of facilitating document validation including generating, using the processing device 1004, at least one digital identifier, in accordance with some embodiments. Further, in some embodiments, the method 400 further may include a step 402 of receiving, using the communication device 1002, one or more user data from one or more institution devices. Further, in some embodiments, the method 400 further may include a step 404 of generating, using the processing device 1004, the one or more second hash values of the one or more user data using one or more hash functions. Further, in some embodiments, the method 400 further may include a step 406 of encrypting, using the processing device 1004, the one or more user data using the one or more encryption keys. Further, in some embodiments, the method 400 further may include a step 408 of generating, using the processing device 1004, one or more digital identifiers. Further, the one or more digital identifiers includes the one or more second hash values and the one or more encryption keys. Further, in some embodiments, the method 400 further may include a step 410 of storing, using the storage device 1006, the one or more second hash values, the one or more encryption keys, and the one or more digital identifiers in the one or more databases.

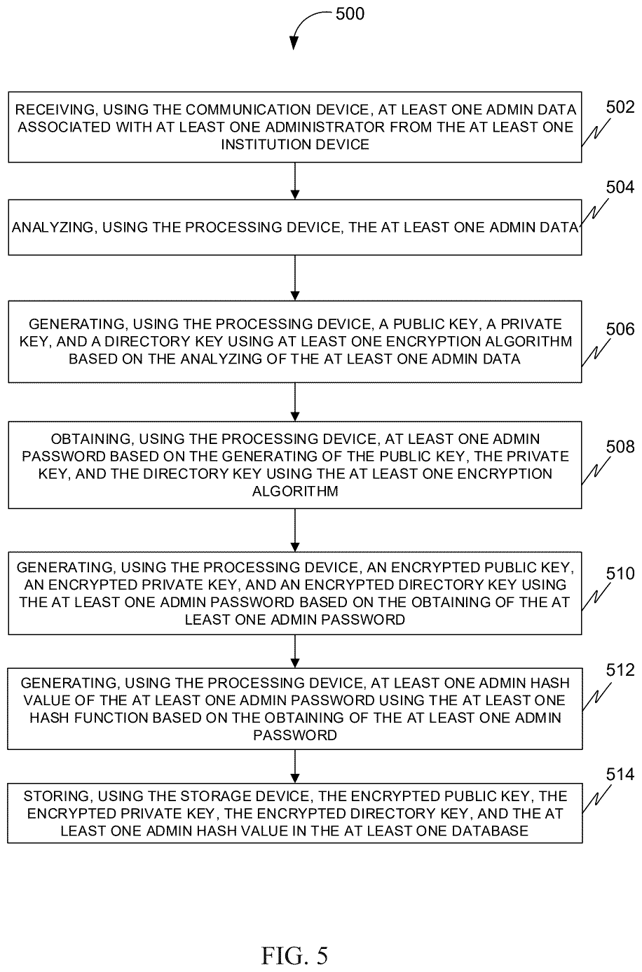

FIG. 5 illustrates a flowchart of a method 500 of facilitating document validation including generating, using the processing device 1004, at least one admin hash value of the at least one admin password using the at least one hash function, in accordance with some embodiments. Further, in some embodiments, the method 500 further may include a step 502 of receiving, using the communication device 1002, one or more admin data associated with one or more administrators from the one or more institution devices. Further, in some embodiments, the method 500 further may include a step 504 of analyzing, using the processing device 1004, the one or more admin data. Further, in some embodiments, the method 500 further may include a step 506 of generating, using the processing device 1004, a public key, a private key, and a directory key using one or more encryption algorithms based on the analyzing of the one or more admin data. Further, in some embodiments, the method 500 further may include a step 508 of obtaining, using the processing device 1004, one or more admin passwords based on the generating of the public key, the private key, and the directory key using the one or more encryption algorithms. Further, in some embodiments, the method 500 further may include a step 510 of generating, using the processing device 1004, an encrypted public key, an encrypted private key, and an encrypted directory key using the one or more admin passwords based on the obtaining of the one or more admin passwords. Further, in some embodiments, the method 500 further may include a step 512 of generating, using the processing device 1004, one or more admin hash values of the one or more admin passwords using the one or more hash functions based on the obtaining of the one or more admin passwords. Further, in some embodiments, the method 500 further may include a step 514 of storing, using the storage device 1006, the encrypted public key, the encrypted private key, the encrypted directory key, and the one or more admin hash values in the one or more databases.

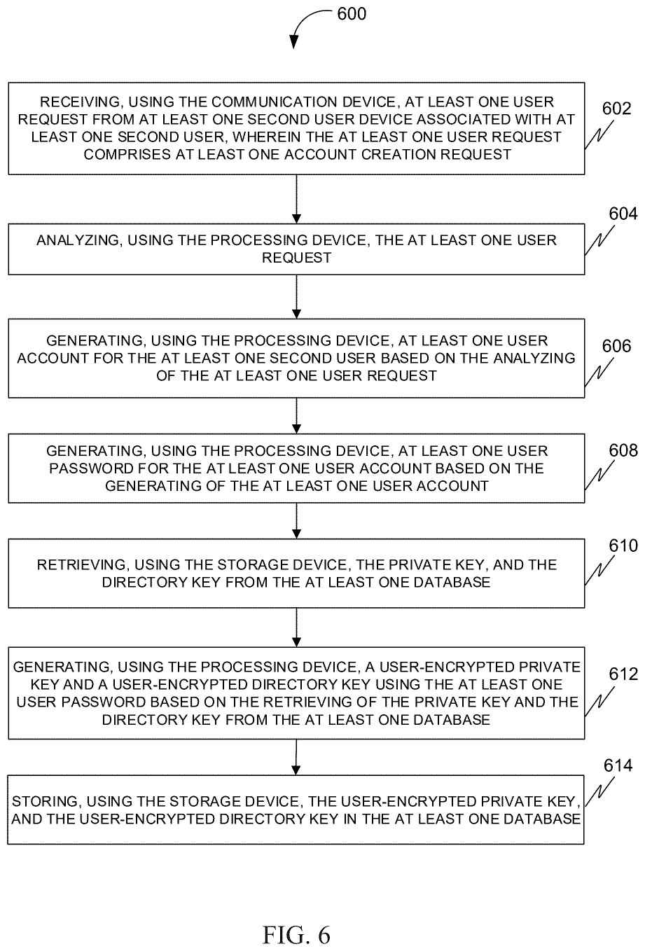

FIG. 6 illustrates a flowchart of a method 600 of facilitating document validation including generating, using the processing device 1004, a user-encrypted private key and a user-encrypted directory key using the at least one user password, in accordance with some embodiments. Further, in some embodiments, the method 600 further may include a step 602 of receiving, using the communication device 1002, one or more user requests from one or more second user devices associated with one or more second users. Further, the one or more user requests include one or more account creation requests. Further, in some embodiments, the method 600 further may include a step 604 of analyzing, using the processing device 1004, the one or more user requests. Further, in some embodiments, the method 600 further may include a step 606 of generating, using the processing device 1004, one or more user accounts for the one or more second users based on the analyzing of the one or more user requests. Further, in some embodiments, the method 600 further may include a step 608 of generating, using the processing device 1004, one or more user passwords for the one or more user accounts based on the generating of the one or more user accounts. Further, in some embodiments, the method 600 further may include a step 610 of retrieving, using the storage device 1006, the private key, and the directory key from the one or more databases. Further, in some embodiments, the method 600 further may include a step 612 of generating, using the processing device 1004, a user-encrypted private key and a user-encrypted directory key using the one or more user passwords based on the retrieving of the private key and the directory key from the one or more databases. Further, in some embodiments, the method 600 further may include a step 614 of storing, using the storage device 1006, the user-encrypted private key, and the user-encrypted directory key in the one or more databases.

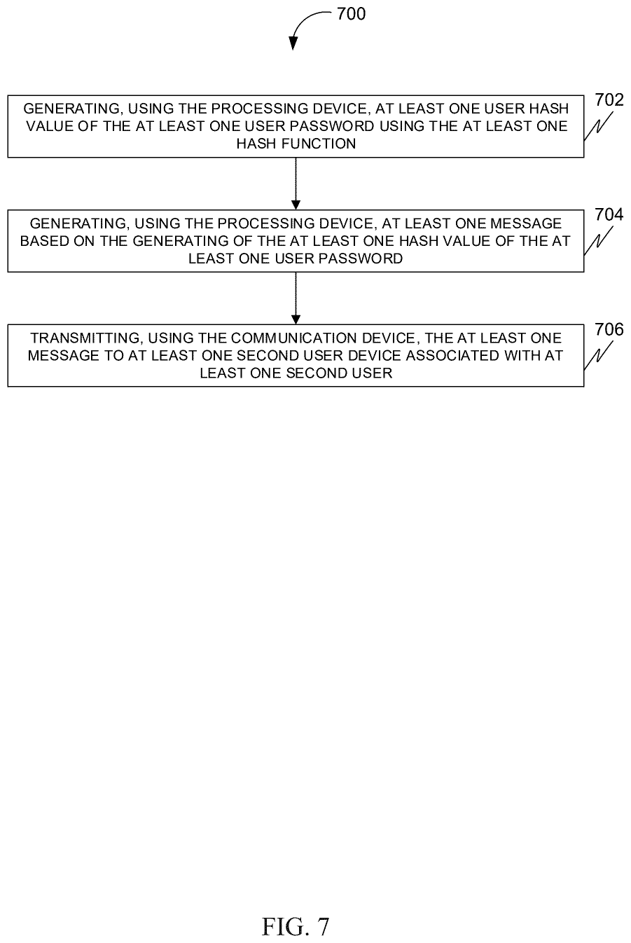

FIG. 7 illustrates a flowchart of a method 700 of facilitating document validation including generating, using the processing device 1004, at least one message, in accordance with some embodiments. Further, in some embodiments, the method 700 further may include a step 702 of generating, using the processing device 1004, one or more user hash values of the one or more user passwords using the one or more hash functions. Further, in some embodiments, the method 700 further may include a step 704 of generating, using the processing device 1004, one or more messages based on the generating of the one or more hash values of the one or more user passwords. Further, in some embodiments, the method 700 further may include a step 706 of transmitting, using the communication device 1002, the one or more messages to one or more second user devices associated with one or more second users.

In some embodiments, the one or more messages represent one or more e-mails. Further, the one or more e-mails include one or more user account information, the one or more user passwords, one or more instructions to validate the one or more user accounts, and the one or more user hash values.

In some embodiments, the generating of the one or more results includes generating one of a positive result and a negative result. Further, the positive result indicates a validity of one or more user data. Further, the negative result indicates an invalidity of the one or more user data.

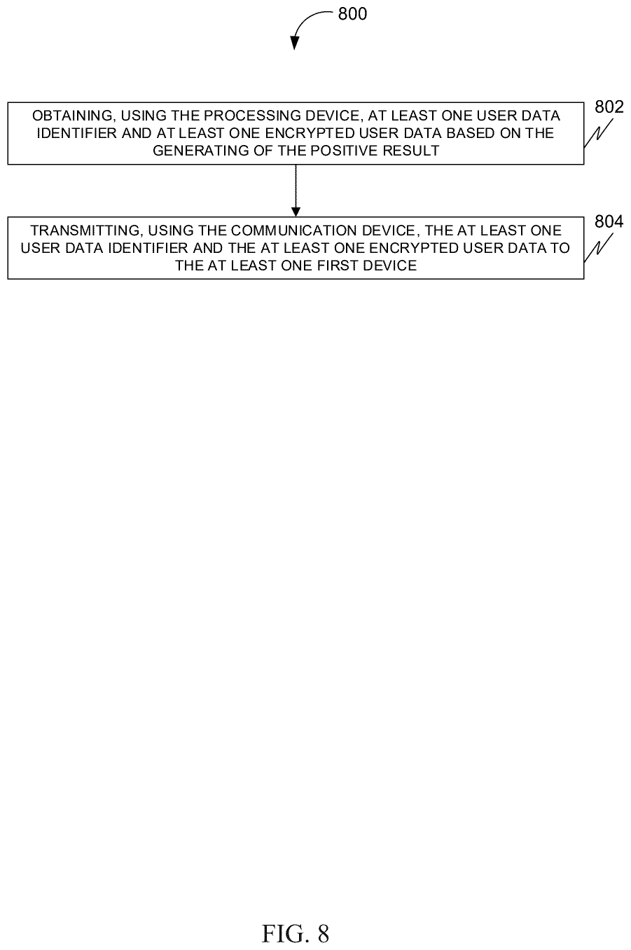

FIG. 8 illustrates a flowchart of a method 800 of facilitating document validation including obtaining, using the processing device 1004, at least one user data identifier and at least one encrypted user data, in accordance with some embodiments. Further, in some embodiments, the method 800 further may include a step 802 of obtaining, using the processing device 1004, one or more user data identifiers and one or more encrypted user data based on the generating of the positive result. Further, in some embodiments, the method 800 further may include a step 804 of transmitting, using the communication device 1002, the one or more user data identifiers and the one or more encrypted user data to the one or more first devices.

FIG. 9 illustrates a flowchart of a method 900 of facilitating document validation including generating, using the processing device 1004, at least one alert, in accordance with some embodiments. Further, in some embodiments, the method 900, further may include a step 902 of deactivating, using the processing device 1004, the one or more digital identifiers based on the generating of the negative result. Further, in some embodiments, the method 900, further may include a step 904 of generating, using the processing device 1004, one or more alerts based on the deactivating of the one or more digital identifiers. Further, in some embodiments, the method 900, further may include a step 906 of transmitting, using the communication device 1002, the one or more alerts to one or more first user devices.

In some embodiments, the one or more user data includes one or more user information and the one or more documents of the one or more users. Further, the one or more documents include one or more of an education document, a medical document, an employment contract, a power of attorney, an email communication, and a legal document. Further, the one or more user information includes one or more of a user name, and a user address.

FIG. 10 illustrates a block diagram of a system 1000 of facilitating document validation, in accordance with some embodiments. Accordingly, the system 1000 may include a communication device 1002. Further, the communication device 1002 may be configured for receiving one or more access requests from one or more first user devices associated with one or more first users. Further, the one or more access requests include one or more first hash values, and one or more encryption keys. Further, the communication device 1002 may be configured for transmitting one or more results to the one or more first user devices. Further, the system 1000 may include a processing device 1004 communicatively coupled with the communication device 1002. Further, the processing device 1004 may be configured for analyzing the one or more first hash values and one or more second hash values. Further, the processing device 1004 may be configured for generating the one or more results based on the analyzing of the one or more first hash values and the one or more second hash values. Further, the system 1000 may include a storage device 1006 communicatively coupled with the processing device 1004. Further, the storage device 1006 may be configured for retrieving the one or more second hash values from one or more databases.

Further, in some embodiments, the communication device 1002 may be further configured for receiving the one or more user data from one or more institution devices. Further, the processing device 1004 may be configured for generating the one or more second hash values of the one or more user data using one or more hash functions.

Further, the processing device 1004 may be configured for encrypting the one or more user data using the one or more encryption keys. Further, the processing device 1004 may be configured for generating one or more digital identifiers. Further, the one or more digital identifiers include the one or more second hash values and the one or more encryption keys. Further, the storage device 1006 may be further configured for storing the one or more second hash values, the one or more encryption keys, and the one or more digital identifiers in the one or more databases.

Further, in some embodiments, the communication device 1002 may be further configured for receiving one or more admin data associated with one or more administrators from the one or more institution devices. Further, the processing device 1004 may be further configured for analyzing the one or more admin data. Further, the processing device 1004 may be further configured for generating a public key, a private key, and a directory key using one or more encryption algorithms based on the analyzing of the one or more admin data. Further, the processing device 1004 may be further configured for obtaining one or more admin passwords based on the generating of the public key, the private key, and the directory key using the one or more encryption algorithms. Further, the processing device 1004 may be further configured for generating an encrypted public key, an encrypted private key, and an encrypted directory key using the one or more admin passwords based on the obtaining of the one or more admin passwords. Further, the processing device 1004 may be further configured for generating one or more admin hash values of the one or more admin passwords using the one or more hash functions based on the obtaining of the one or more admin passwords. Further, the storage device 1006 may be further configured for storing the encrypted public key, the encrypted private key, the encrypted directory key, and the one or more admin hash values in the one or more databases.

Further, in some embodiments, the communication device 1002 may be further configured for receiving one or more user requests from one or more second user devices associated with one or more second users. Further, the one or more user requests may include one or more account creation requests. Further, the processing device 1004 may be further configured for analyzing the one or more user requests. Further, the processing device 1004 may be further configured for generating one or more user accounts for the one or more second users based on the analyzing of the one or more user requests. Further, the processing device 1004 may be further configured for generating one or more user passwords for the one or more user accounts based on the generating of the one or more user accounts. Further, the processing device 1004 may be further configured for generating a user-encrypted private key and a user-encrypted directory key using the one or more user passwords based on retrieving of a private key and a directory key from the one or more databases. Further, the storage device 1006 may be further configured for. retrieving the private key, and the directory key from the one or more databases. Further, the storage device 1006 may be further configured for storing the user-encrypted private key and the user-encrypted directory key in the one or more databases.

Further, in some embodiments, the communication device 1002 may be further configured for transmitting one or more messages to one or more second user devices associated with one or more second users. Further, the processing device 1004 may be further configured for generating one or more user hash values of the one or more user passwords using the one or more hash functions. Further, the processing device 1004 may be further configured for generating the one or more messages based on the generating of the one or more hash values of the one or more user passwords.

In some embodiments, the one or more messages represent one or more e-mails. Further, the one or more e-mails include one or more user account information, the one or more user passwords, one or more instructions to validate the one or more user accounts, and the one or more user hash values.

In some embodiments, the generating of the one or more results includes generating one of a positive result and a negative result. Further, the positive result indicates a validity of one or more user data. Further, the negative result indicates an invalidity of the one or more user data.

In some embodiments, the communication device 1002 may be further configured for transmitting one or more user data identifiers and one or more encrypted user data to the one or more first devices. Further, the processing device 1004 may be further configured for obtaining the one or more user data identifiers and the one or more encrypted user data based on the generating of the positive result.

Further, in some embodiments, the communication device 1002 may be further configured for transmitting one or more alerts to one or more first user devices. Further, the processing device 1004 may be further configured for deactivating the one or more digital identifiers based on the generating of the negative result. Further, the processing device 1004 may be further configured for generating the one or more alerts based on the deactivating of the one or more digital identifiers.

In some embodiments, the one or more user data includes one or more user information and the one or more documents of the one or more users. Further, the one or more documents include one or more of an education document, a medical document, an employment contract, a power of attorney, an email communication, and a legal document. Further, the one or more user information includes one or more of a user name, and user address

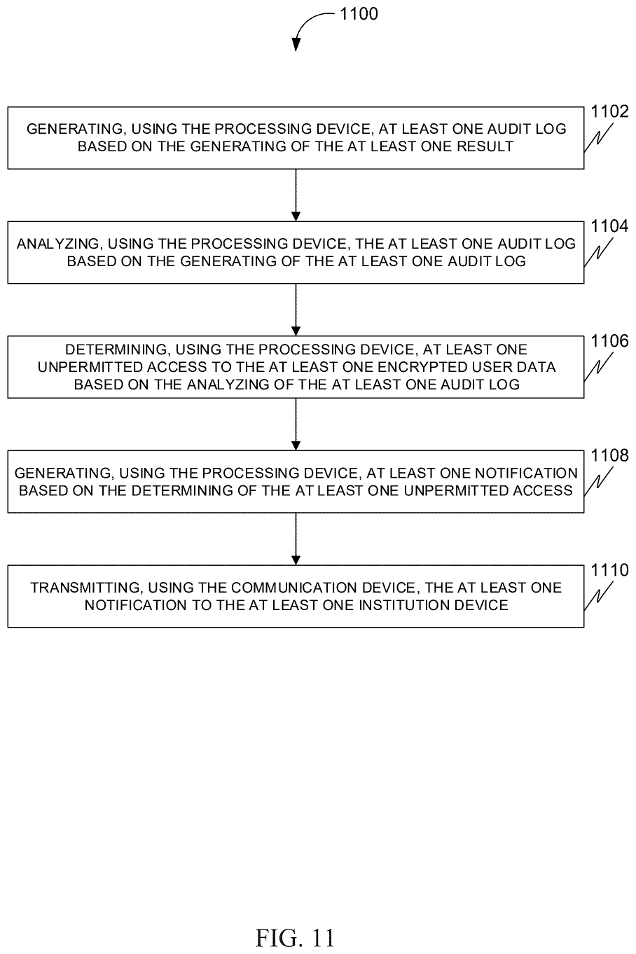

FIG. 11 illustrates a flowchart of a method 1100 of facilitating document validation including generating, using the processing device 1004, at least one notification, in accordance with some embodiments. Further, in some embodiments, the method 1100 further may include a step 1102 of generating, using the processing device 1004, one or more audit logs based on the generating of the one or more results. Further, in some embodiments, the method 1100 further may include a step 1104 of analyzing, using the processing device 1004, the one or more audit logs based on the generating of the one or more audit logs. Further, in some embodiments, the method 1100 further may include a step 1106 of determining, using the processing device 1004, one or more unpermitted access to the one or more encrypted user data based on the analyzing of the one or more audit logs. Further, in some embodiments, the method 1100 further may include a step 1108 of generating, using the processing device 1004, one or more notifications based on the determining of the one or more unpermitted accesses. Further, in some embodiments, the method 1100 further may include a step 1110 of transmitting, using the communication device 1002, the one or more notifications to the one or more institution devices.

In some embodiments, the one or more audit logs may be used for real-time tracking of one or more actions of the one or more first users and the one or more administrators. Further, the one or more actions include one or more of a key generation, a document certification, a document verification, and a QR code deactivation.

Further, in some embodiments, the one or more first user devices, and the one or more second user devices include a user communication device, a user processing device, and a user storage device. Further, the user processing device may be configured for obtaining one or more digital certificates of one or more applications issued by one or more app stores. Further, the user processing device may be configured for analyzing the one or more digital certificates. Further, the user processing device may be configured for verifying an authenticity of one or more digital certificates based on the analyzing of the one or more digital certificates. Further, the user processing device may be configured for generating one or more responses based on the verifying of the authenticity of the one or more digital certificates. Further, the one or more applications may be traceable to the one or more app stores based on the one or more responses.

Further, in some embodiments, the user processing device may be further configured for scanning the one or more digital identifiers attached to one or more documents. Further, the user processing device may be further configured for analyzing the one or more digital identifiers. Further, the user processing device may be further configured for determining the one or more first hash values and the one or more encryption keys based on the analyzing of the one or more digital identifiers. Further, the user processing device may be further configured for generating one or more access requests based on the determining of the one or more first hash values and the one or more encryption keys.

Further, in some embodiments, the user communication device may be configured for receiving the one or more encrypted user data, the one or more user data identifiers. Further, the user processing device may be further configured for decrypting the one or more encrypted user data using the one or more encryption keys. Further, the user processing device may be further configured for obtaining the one or more user data based on the decrypting of the one or more encrypted user data using the one or more encryption keys. Further, the user storage device may be configured for storing the one or more user data.

In some embodiments, the one or more first users represent one or more of a prior verifier of the one or more documents, and a current verifier of the one or more documents. Further, the one or more first users includes one or more of an employer, a health care provider, a customs official, and a government agency.

In some embodiments, the one or more encryption algorithms include one or more of a symmetric encryption algorithm, and an asymmetric algorithm. Further, the one or more encryption algorithms include one or more of AES-256, RSA, and an elliptic curve cryptography algorithm.

In some embodiments, the one or more hash functions include one or more of a SHA256, a SHA3-256, and a BLAKE.

In some embodiments, the one or more encryption keys include one or more 64-character reading keys. Further, the one or more 64-character reading keys may be one or more symmetric encryption keys.

In some embodiments, the generating of the one or more digital identifiers includes asymmetrically encrypting the one or more digital identifiers using the one or more public keys.

In some embodiments, the one or more of the public key, the private key, the directory key, and the one or more encryption keys may be generated using one or more cryptographically secure random number generators.

In some embodiments, the receiving of the one or more access requests may be facilitated using one or more application programming interfaces. Further, the one or more application programming interfaces may be configured to automate certification and verification of the one or more documents.

In some embodiments, the one or more digital identifiers include one or more of a QR code, a barcode, a data matrix, and an Aztec code.

In some embodiments, one or more encrypted user data may be stored in a binary security format (blob).

FIG. 12 illustrates a flowchart of an account registration process 1200 for facilitating document validation, in accordance with some embodiments. Further, in some embodiments, the account registration process 1200 includes administrator registration. Further, in some embodiments, the account registration process 1200 includes an administrator input 1202. Further, the administrator input 1202 comprises the administrator entering one or more of an institution name, an institution address, an administrator's first name, and last name, an administrator's email address, and an administrator password 1202. Further, in some embodiments, the account registration process 1200 further includes an administrator browser 1204. Further, the administrator browser 1204 facilitates a random key generation 1206, a symmetric encryption with administrator password 1208, and a hash using SHA256 of the administrator password 1210. Further, the random key generation includes randomly generating the public key, the private key, and a 64-character directory key. Further, the symmetric encryption with administrator password 1208 includes symmetrically encrypting the public key, the private key, and the directory key using the administrator password. Further, the hash using SHA256 of the administrator password 1210 comprises generating a SHA256 hash of the administrator password. Further, in some embodiments, the account registration process 1200 further includes storing the institution name, the institution address, the administrator's first name and last name, the administrator's email address, the encrypted public key, the encrypted private key, and the encrypted directory key, and the SHA256 hash of the administrator password in a system database 1212.

FIG. 13 illustrates a flowchart of an account creation process 1300 for at least one additional user, in accordance with some embodiments. Further, in some embodiments, the account creation process 1300 for one or more additional users includes an administrator input 1302. Further, the administrator input 1302 the administrator entering one or more of a user's first name and last name, and a user's email address. Further, in some embodiments, the account creation process 1300 for one or more additional users further includes the administrator's browser 1204. Further, the administrator's browser 1204 facilitates a random key generation 1304, a symmetric encryption with a temporary password 1306, and a hash using SHA256 1308, and sets an administrator status as false 1310. Further, random key generation 1304 includes generating the temporary password for the user. Further, the symmetric encryption with a temporary password 1306 includes symmetrically encrypting the public key, the private key, and the 64-character directory key using the temporary password. Further, the hash using SHA256 1308 includes generating a SHA256 hash of the temporary password 1308. Further, in some embodiments, the account creation process 1300 for one or more additional users further includes storing the administrator status, the institution name, the institution address, the user's first name, and last name, the user's email address, the encrypted public key, the encrypted private key, and the encrypted directory key, and the SHA256 hash of the temporary password in a system database 1212. Further, in some embodiments, the account creation process 1300 for one or more additional users further includes email transmission 1312. Further, the email transmission 1312 includes transmitting the email containing a user login, the temporary password, and a confirmation link to the user. Further, the confirmation link includes the hash value of the temporary password.

FIG. 14 illustrates a flowchart of an email confirmation 1400, in accordance with some embodiments. Further, in some embodiments, the email confirmation 1400 includes a user confirmation 1402. Further, the user confirmation 1402 includes the user clicking on a received email. Further, in some embodiments, the email confirmation 1400 further includes querying the system database 1212. Further, in some embodiments, the email confirmation 1400 further includes determining a hash value match 1404. Further, the determining of the hash value match 1404 comprises determining the hash value of the temporary password in the system database 1212. Further, in some embodiments, the email confirmation 1400 further includes displaying an invalid request 1406 if the hash value match is a No. Further, in some embodiments, the email confirmation 1400 further includes setting a true status 1408 and changing the temporary password if the hash value match 1404 is Yes. Further, in some embodiments, the email confirmation 1400 further includes a user input 1410. Further, the user input 1410 comprises the temporary password and a new password. Further, in some embodiments, the email confirmation 1400 further includes a user browser 1412. Further, the user browser facilitates a decryption with the temporary password 1414, a symmetric encryption with the new password 1416, and a hash using SHA256 1418. Further, the decryption with the temporary password 1414 includes decrypting the encrypted private key, the encrypted public key, and the 64-character directory key using the temporary password. Further, the symmetric encryption with the new password 1416 includes symmetrically encrypting the public key, the private key, and the 64-character directory key using the new password. Further, the hash using SHA256 1418 includes generating a SHA256 hash of the new password.

FIG. 15 illustrates a flowchart of a certification process 1500, in accordance with some embodiments. Further, in some embodiments, the certification process 1500 includes an input from one or more of the administrator and the user 1502. Further, the input from the one or more of the administrator and the user 1502 comprises a student's first name, last name, a student's information, a document awarded, and a graduation date. Further, in some embodiments, the certification process 1500 further includes an encoder's browser 1504. Further, the encoder's browser facilitates a hash using SHA256 with “salt” derived from the directory key 1506, a random key generation 1508, and a symmetric encryption with reading key 1510, a QR code image generation 1512, and an asymmetric encryption 1514. Further, the hash using SHA256 with “salt” derived from the directory key 1506 comprises generating a SHA256 hash of one or more of the document information, a first letter of student' last name, first two letters of the student' last name, first three letters of the student' last name, and first four letters of the student's last name. Further, the random key generation 1508 comprises generating a 64-character reading key. Further, the symmetric encryption with reading key 1510 comprises symmetrically encrypting the document information using the 64-character reading key. Further, the QR code image generation 1512 comprises generating a QR code containing the SHA256 hash of the document information and the 64-character reading key. Further, the asymmetric encryption 1514 includes asymmetrically encrypting a comment, the student's first name, and last name, the student's information, and the QR code image. Further, in some embodiments, the certification process 1500 further includes storing the document awarded, an encrypted comment, encrypted student's first and last name, encrypted student's information, encrypted QR code image, encrypted document information, and the SHA256 hash of the first letter of student' last name, the first two letters of the student' last name, the first three letters of the student' last name, and the first four letters of the student's last name in the system database 1212.

FIG. 16 illustrates a flowchart of a verification process 1600, in accordance with some embodiments. Further, in some embodiments, the verification process 1600 includes a QR-code verification. Further, in some embodiments, the verification process 1600 includes scanning the QR code 1602. Further, in some embodiments, the verification process 1600 further includes splitting the first hash value of the document information and the 64-character reading key from the QR code. Further, in some embodiments, the verification process 1600 further includes querying the system database 1212. Further, in some embodiments, the verification process 1600 includes retrieving a second hash value from the system database 1212. Further, in some embodiments, the verification process 1600 includes determining a document hash value match 1608 by analyzing the first hash value and the second hash value of the document information. Further, in some embodiments, the verification process 1600 further includes generating a fraudulent document message 1604 if the document hash value match is a No. Further, in some embodiments, the verification process 1600 includes determining a status 1610 if the document hash value match is a Yes. Further, the determining of the status 1610 includes determining one of a true status and a false status Further, in some embodiments, the verification process 1600 further includes generating a revoked document message 1606 if the status is false. Further, in some embodiments, the verification process 1600 further includes returning a document ID, status 1610, and the document information from the system database 1212. Further, in some embodiments, the verification process 1600 further includes decrypting the document information using the 64-character reading key. Further, in some embodiments, the verification process 1600 includes displaying the document information 1612.

Although the invention has been explained in relation to its preferred embodiment, it is to be understood that many other possible modifications and variations can be made without departing from the spirit and scope of the invention as hereinafter claimed.

What is claimed is:

1. A method of facilitating document validation, the method comprising:
receiving, using a communication device, at least one access request from at least one first user device associated with at least one first user, wherein the at least one access request comprises at least one first hash value, and at least one encryption key;
retrieving, using a storage device, at least one second hash value from at least one database;
analyzing, using a processing device, the at least one first hash value and the at least one second hash value;
generating, using the processing device, at least one result based on the analyzing of the at least one first hash value and the at least one second hash value; and
transmitting, using the communication device, the at least one result to the at least one first user device.

2. The method of claim 1 further comprising:
receiving, using the communication device, at least one user data from at least one institution device;
generating, using the processing device, the at least one second hash value of the at least one user data using at least one hash function;
encrypting, using the processing device, the at least one user data using the at least one encryption key;
generating, using the processing device, at least one digital identifier, wherein the at least one digital identifier comprises the at least one second hash value and the at least one encryption key; and
storing, using the storage device, the at least one second hash value, the at least one encryption key, and the at least one digital identifier in the at least one database.

3. The method of claim 2 further comprising:
receiving, using the communication device, at least one admin data associated with at least one administrator from the at least one institution device;
analyzing, using the processing device, the at least one admin data;
generating, using the processing device, a public key, a private key, and a directory key using at least one encryption algorithm based on the analyzing of the at least one admin data;
obtaining, using the processing device, at least one admin password based on the generating of the public key, the private key, and the directory key using the at least one encryption algorithm;
generating, using the processing device, an encrypted public key, an encrypted private key, and an encrypted directory key using the at least one admin password based on the obtaining of the at least one admin password;
generating, using the processing device, at least one admin hash value of the at least one admin password using the at least one hash function based on the obtaining of the at least one admin password; and
storing, using the storage device, the encrypted public key, the encrypted private key, the encrypted directory key, and the at least one admin hash value in the at least one database.

4. The method of claim 3 further comprising:
receiving, using the communication device, at least one user request from at least one second user device associated with at least one second user, wherein the at least one user request comprises at least one account creation request;
analyzing, using the processing device, the at least one user request;
generating, using the processing device, at least one user account for the at least one second user based on the analyzing of the at least one user request;
generating, using the processing device, at least one user password for the at least one user account based on the generating of the at least one user account;
retrieving, using the storage device, the private key, and the directory key from the at least one database;
generating, using the processing device, a user-encrypted private key and a user-encrypted directory key using the at least one user password based on the retrieving of the private key and the directory key from the at least one database; and
storing, using the storage device, the user-encrypted private key, and the user-encrypted directory key in the at least one database.

5. The method of claim 4 further comprising:
generating, using the processing device, at least one user hash value of the at least one user password using the at least one hash function;
generating, using the processing device, at least one message based on the generating of the at least one hash value of the at least one user password; and
transmitting, using the communication device, the at least one message to at least one second user device associated with at least one second user.

6. The method of claim 5, wherein the at least one message represents at least one e-mail, wherein the at least one e-mail comprises at least one user account information, the at least one user password, at least one instruction to validate the at least one user account, and the at least one user hash value.

7. The method of claim 2, further comprising:
deactivating, using the processing device, the at least one digital identifier based on the generating of the negative result;
generating, using the processing device, at least one alert based on the deactivating of the at least one digital identifier; and
transmitting, using the communication device, the at least one alert to at least one first user device.

8. The method of claim 1, wherein the generating of the at least one result comprises generating one of a positive result and a negative result, wherein the positive result indicates a validity of at least one user data, wherein the negative result indicates an invalidity of the at least one user data.

9. The method of claim 8, further comprising:
obtaining, using the processing device, at least one user data identifier and at least one encrypted user data based on the generating of the positive result; and
transmitting, using the communication device, the at least one user data identifier and the at least one encrypted user data to the at least one first device.

10. The method of claim 1, wherein the at least one user data comprises at least one user information and the at least one document of the at least one user, wherein the at least one document comprises at least one of an education document, a medical document, an employment contract, a power of attorney, an email communication, and a legal document, wherein the at least one user information comprises at least one of a user name, and user address.

11. A system for facilitating document validation, the system comprising:
a communication device configured for:
receiving at least one access request from at least one first user device associated with at least one first user, wherein the at least one access request comprises at least one first hash value, and at least one encryption key; and
transmitting at least one result to the at least one first user device;
a processing device communicatively coupled with the communication device, wherein the processing device is configured for:
analyzing the at least one first hash value and at least one second hash value;
generating the at least one result based on the analyzing of the at least one first hash value and the at least one second hash value; and
a storage device communicatively coupled with the processing device, wherein the storage device is configured for:
retrieving the at least one second hash value from at least one database.

12. The system of claim 11, wherein the communication device is further configured for receiving the at least one user data from at least one institution device, wherein the processing device is configured for:
generating the at least one second hash value of the at least one user data using at least one hash function;
encrypting the at least one user data using the at least one encryption key;
generating at least one digital identifier, wherein the at least one digital identifier comprises the at least one second hash value and the at least one encryption key, wherein the storage device is further configured for storing the at least one second hash value, the at least one encryption key, and the at least one digital identifier in the at least one database.

13. The system of claim 12, wherein the communication device is further configured for receiving at least one admin data associated with at least one administrator from the at least one institution device, wherein the processing device is further configured for:
analyzing the at least one admin data;
generating a public key, a private key, and a directory key using at least one encryption algorithm based on the analyzing of the at least one admin data;
obtaining at least one admin password based on the generating of the public key, the private key, and the directory key using the at least one encryption algorithm;
generating an encrypted public key, an encrypted private key, and an encrypted directory key using the at least one admin password based on the obtaining of the at least one admin password; and
generating at least one admin hash value of the at least one admin password using the at least one hash function based on the obtaining of the at least one admin password, wherein the storage device is further configured for storing the encrypted public key, the encrypted private key, the encrypted directory key, and the at least one admin hash value in the at least one database.

14. The system of claim 13, wherein the communication device is further configured for receiving at least one user request from at least one second user device associated with at least one second user, wherein the at least one user request comprises at least one account creation request, wherein the processing device is further configured for:
analyzing the at least one user request;
generating at least one user account for the at least one second user based on the analyzing of the at least one user request;
generating at least one user password for the at least one user account based on the generating of the at least one user account;
generating a user-encrypted private key and a user-encrypted directory key using the at least one user password based on retrieving of a private key and a directory key from the at least one database, wherein the storage device is further configured for:
retrieving the private key, and the directory key from the at least one database; and
storing the at least one user-encrypted private key, and the user-encrypted directory key in the at least one database.

15. The system of claim 14, wherein the communication device is further configured for transmitting at least one message to at least one second user device associated with at least one second user, wherein the processing device is further configured for:
generating at least one user hash value of the at least one user password using the at least one hash function; and
generating the at least one message based on the generating of the at least one hash value of the at least one user password.

16. The system of claim 15, wherein the at least one message represents at least one e-mail, wherein the at least one e-mail comprises at least one user account information, the at least one user password, at least one instruction to validate the at least one user account, and the at least one user hash value.

17. The system of claim 11, wherein the generating of the at least one result comprises generating one of a positive result and a negative result, wherein the positive result indicates a validity of at least one user data, wherein the negative result indicates an invalidity of the at least one user data.

18. The system of claim 17, wherein the communication device is further configured for transmitting at least one user data identifier and at least one encrypted user data to the at least one first device, wherein the processing device is further configured for obtaining the at least one user data identifier and the at least one encrypted user data based on the generating of the positive result.

19. The system of claim 17, wherein the communication device is further configured for transmitting at least one alert to at least one first user device, wherein the processing device is further configured for:
deactivating the at least one digital identifier based on the generating of the negative result; and
generating the at least one alert based on the deactivating of the at least one digital identifier.

20. The system of claim 11, wherein the at least one user data comprises at least one user information and the at least one document of the at least one user, wherein the at least one document comprises at least one of an education document, a medical document, an employment contract, a power of attorney, an email communication, and a legal document, wherein the at least one user information comprises at least one of a user name, and user address.
